(19) United States
(12) Patent Application Publication
(10) Pub. No.: US 2016/0291899 A1
(43) Pub. Date: Oct. 6, 2016

(54) STORAGE CONTROL DEVICE AND STORAGE SYSTEM

(71) Applicant: FUJITSU LIMITED, Kawasaki-shi (JP)

(72) Inventors: Tatsushi TAKAMURA, Sagamihara (JP); Junji Ikeda, Yokohama (JP); Yoshiyuki Terai, Kawasaki (JP)

(73) Assignee: FUJITSU LIMITED, Kawasaki-shi (JP)

(21) Appl. No.: 15/062,713

(22) Filed: Mar. 7, 2016

(30) Foreign Application Priority Data
Mar. 31, 2015 (JP) 2015-072986

(51) Int. Cl. G06F 3/06

(52) U.S. Cl. CPC G06F 3/0647; G06F 3/0604; G06F 3/0629; G06F 3/0689

(57) ABSTRACT

A storage control device includes a processor. The processor is configured to receive a designation of a target volume among a plurality of volumes including a plurality of data pieces distributively arranged in a plurality of storage apparatuses. The target volume is to be migrated from a first storage apparatus among the plurality of storage apparatuses to a second storage apparatus different from the plurality of storage apparatuses. The processor is configured to determine a layout of first data pieces of the target volume on basis of a number of data pieces arrangeable in the first storage apparatus and a first number indicating a number of data pieces of the target volume. The processor is configured to perform a control operation, on basis of the determined layout, such that the first data pieces are arranged in the first storage apparatus and collectively migrated to the second storage apparatus.

### CROSS-REFERENCE TO RELATED APPLICATION

This application is based upon and claims the benefit of priority from the prior Japanese Patent Application No. 2015-072986 filed on Mar. 31, 2015, the entire contents of which are incorporated herein by reference.

### FIELD

The embodiment discussed herein is related to a storage control device and a storage system.

### BACKGROUND

A technology called scale-out storage has been known in which a plurality of storage apparatuses are linked and operated as a single system. A technology called wide striping has been known in which segments of a volume are distributed over a plurality of storage apparatuses in order to suppress concentration of loads for input and output.

In the scale-out storage, when a capacity or performance is insufficient, an exchange of storage apparatus (hereinafter, also referred to as a node) is performed. A currently operated storage apparatus approaching a maintenance deadline may be exchanged with a new storage apparatus. In the exchange of the storage apparatus, data migration is performed. As a technology on the data migration, for example, the following two technologies have been suggested.

As a first technology, there is a storage system including a higher-level device and a control device. The higher-level device copies data stored in a first volume within a first storage apparatus into a corresponding second volume within a second storage apparatus in units of files. The control device controls the first and second storage apparatuses to copy the data stored in the first volume into the second volume in units of volumes. The storage system determines whether in units of volumes or units of files the data stored in the first volume is to be migrated, in accordance with the state of data stored in the first volume subjected to the data migration.

As a second technology, there is a storage system including a higher-level device, a control device, and a data migration controller. The higher-level device reads data stored in a first volume within a first storage apparatus in units of files from the first storage apparatus, and copies the read data into a corresponding second volume within a second storage apparatus. The control device controls the first and second storage apparatuses to copy the data stored in the first volume into the second volume in units of volumes. The data migration controller determines whether in a first data migration method, in which data is migrated in units of volumes, or a second data migration method, in which data is migrated in units of files, the data stored in the first volume is to be migrated, in accordance with the state of data stored in the first volume. Then, the data migration controller performs a control operation required for executing data migration in the determined first or second data migration method.

Related techniques are disclosed in, for example, Japanese Laid-Open Patent Publication No. 2009-211132, and Japanese Laid-Open Patent Publication No. 2013-033515.

When data is migrated to a new storage apparatus from a currently operated storage apparatus in a state where the data is distributed in a plurality of storage apparatuses, data which does not need to be migrated is also migrated. Thus, it is difficult to perform efficient data migration. The data migration is preferably performed while the operation of the system is continued.

### SUMMARY

According to an aspect of the present invention, provided is a storage control device including a processor. The processor is configured to receive a designation of a target volume among a plurality of volumes including a plurality of data pieces distributively arranged in a plurality of storage apparatuses. The target volume is to be migrated from a first storage apparatus among the plurality of storage apparatuses to a second storage apparatus different from the plurality of storage apparatuses. The processor is configured to determine a layout of first data pieces of the target volume on basis of a number of data pieces arrangeable in the first storage apparatus and a first number indicating a number of data pieces of the target volume. The first data pieces are to be arranged in the first storage apparatus. The processor is configured to perform a control operation, on basis of the determined layout, such that the first data pieces are arranged in the first storage apparatus and the arranged first data pieces are collectively migrated to the second storage apparatus.

The object and advantages of the invention will be realized and attained by means of the elements and combinations particularly pointed out in the claims. It is to be understood that both the foregoing general description and the following detailed description are exemplary and explanatory and are not restirctive of the invention, as claimed.

### BRIEF DESCRIPTION OF DRAWINGS

FIG. 1 is a diagram illustrating an exemplary functional configuration of a storage control device according to an embodiment;

FIG. 2 is a diagram illustrating an example of a storage system;

FIG. 3 is a diagram illustrating an exemplary physical configuration of a virtual storage apparatus;

FIG. 4 is a diagram illustrating an exemplary configuration of scale-out storage;

FIG. 5 is a diagram illustrating an example of a storage system to which a new node is added;

FIG. 6 is a diagram illustrating an example of wide-striping;

FIG. 7 is a diagram illustrating an example of distributive arrangement information managed by a volume management manager;

FIG. 8 is a diagram illustrating an exemplary functional configuration of a self-reconstruction manager;

FIGS. 9A and 9B illustrate an example of volume rearrangement;

FIG. 10 is a diagram illustrating an example of a storage system after segment rearrangement has been performed;

FIG. 11 is a diagram illustrating volume migration;

FIG. 12 is a diagram illustrating volume migration;

FIG. 13 is a diagram illustrating volume migration;

FIG. 14 is a diagram illustrating an exemplary functional configuration of a rearrangement controller;

FIG. 15 is a diagram illustrating an example of an arrangement of segments before segment rearrangement is performed;

FIG. 16 is a diagram illustrating an exemplary data structure of arrangement management information;

FIGS. 17A and 17B are diagrams illustrating optimum arrangement information;

FIGS. 18A to 18C are diagrams illustrating expulsion of segments of a volume other than a migration target;

FIGS. 19A to 19C are diagrams illustrating a movement of segments dropped from a layout indicated by optimum arrangement information to a rear end;

FIGS. 20A to 20C are diagrams illustrating a movement of segments included in a layout indicated by optimum arrangement information;

FIGS. 21A to 21C are diagrams illustrating migration (first time) of a segment group;

FIGS. 22A and 22B are diagrams illustrating optimum arrangement information on segments not yet been migrated;

FIGS. 23A to 23C are diagrams illustrating a rearrangement (second time) of segments based on optimum arrangement information;

FIGS. 24A to 24C are diagrams illustrating migration (second time) of a segment group;

FIG. 25 is a flowchart illustrating an example of migration of a volume according to an embodiment;

FIG. 26 is an example of a flowchart illustrating creation of optimum arrangement information;

FIG. 27 is a diagram illustrating rearrangement processing in a comparative example;

FIG. 28 is a diagram illustrating rearrangement processing in an embodiment; and

FIG. 29 is a diagram illustrating an exemplary hardware configuration of a controller according to an embodiment.

### DESCRIPTION OF EMBODIMENT

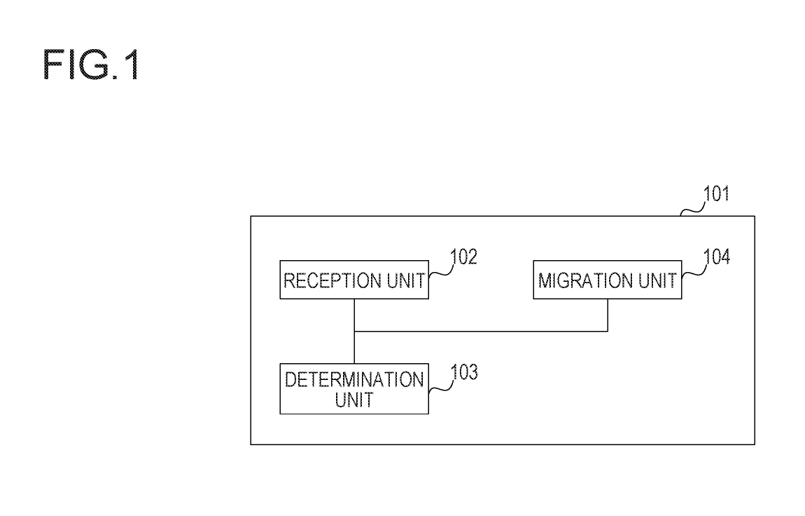

FIG. 1 illustrates an exemplary functional configuration of a storage control device according to an embodiment. In FIG. 1, a storage control device 101 includes a reception unit 102, a determination unit 103, and a migration unit 104.

The reception unit 102 receives a designation of a target volume to be migrated from a migration origin storage apparatus to a migration destination storage apparatus, among a plurality of volumes including a plurality of data pieces distributed and arranged in a plurality of storage apparatuses. The determination unit 103 determines a layout of data pieces of the target volume to be arranged within the migration origin storage apparatus, on the basis of the number of data pieces arrangeable within the migration origin storage apparatus and the number of data pieces of the target volume. The migration unit 104 performs a control operation, on the basis of the determined layout, such that the data pieces of the target volume are arranged (rearranged) in the migration origin storage apparatus and the arranged data pieces are collectively migrated to the migration destination storage apparatus.

The storage control device 101 performs an arrangement of the data pieces in accordance with the layout determined on the basis of the number of data pieces arrangeable within the migration origin storage apparatus and the number of data pieces of the target volume, and then collectively migrates the arranged data. Accordingly, the storage control device 101 may maximize an amount of data that may be migrated collectively. The storage control device 101 may reduce an amount of management messages communicated for migration. Thus, the storage control device 101 may easily perform a management in the migration, and efficiently perform the migration.

The storage control device 101 determines the layout on the basis of the number of data pieces arrangeable within the migration origin storage apparatus and the number of data pieces of the target volume, and performs the arrangement on the basis of the layout. That is, the arrangement is performed on the basis of an optimum layout determined prior to the arrangement. Accordingly, the storage control device 101 may reduce the number of times of moving (copying) the segments within a node, which may occur during the arrangement.

When the number of data pieces of the target volume is larger than an arrangement number indicating the number of data pieces arrangeable consecutively in the migration origin storage apparatus, the determination unit 103 determines the layout as described below. That is, the determination unit 103 determines the layout for respective groups of the arrangement number of data pieces such that data pieces of the target volume are consecutively arranged in order of address of the data pieces in the target volume from one end of a predetermined storage area of the migration origin storage apparatus. The migration unit 104 performs, on the basis of the determined layout, a control operation for the respective groups of the arrangement number of data pieces such that the data pieces of the target volume are arranged in the migration origin storage apparatus and then the arranged data pieces are collectively migrated to the migration destination storage apparatus.

The storage control device 101 determines the layout for the respective groups of the arrangement number of data pieces such that the data pieces are consecutively arranged in order of address of the data pieces in the target volume. Accordingly, the storage control device 101 may efficiently perform the migration even for a large volume which does not completely fit in a migration origin node.

When the number of data pieces of the target volume is larger than the arrangement number, the determination unit 103 determines the layout such that data pieces, which are present in the storage area and at address orders later than the arrangement number among data pieces not yet migrated, are consecutively arranged from the other end of the storage area. Then, the migration unit 104 performs a control operation such that data pieces are to be arranged on the basis of the layout, and the data pieces at address orders within the arrangement number are collectively migrated.

The storage control device 101 determines the layout such that the data pieces, which are present in the storage area and at address orders later than the arrangement number among data pieces not yet migrated, are consecutively arranged from the other end of the storage area. Accordingly, the storage control device 101 may suppress the communication traffic between storage apparatuses during the arrangement in the migration origin storage apparatus.

The migration unit 104 changes the arrangement number in accordance with the number of data pieces which are present in the storage area and at address orders later than the arrangement number among data pieces not yet migrated. Accordingly, the storage control device 101 may suppress the communication traffic between storage apparatuses during the arrangement in the migration origin storage apparatus.

The reception unit 102 receives a designation of a non-target volume which is not to be migrated from the migration origin storage apparatus to the migration destination storage apparatus. The migration unit 104 arranges data pieces included in the non-target volume, among the data pieces present in the storage area, in a storage apparatus other than the migration origin storage apparatus. Accordingly, the storage control device 101 may maximize an amount of data that may be collectively migrated.

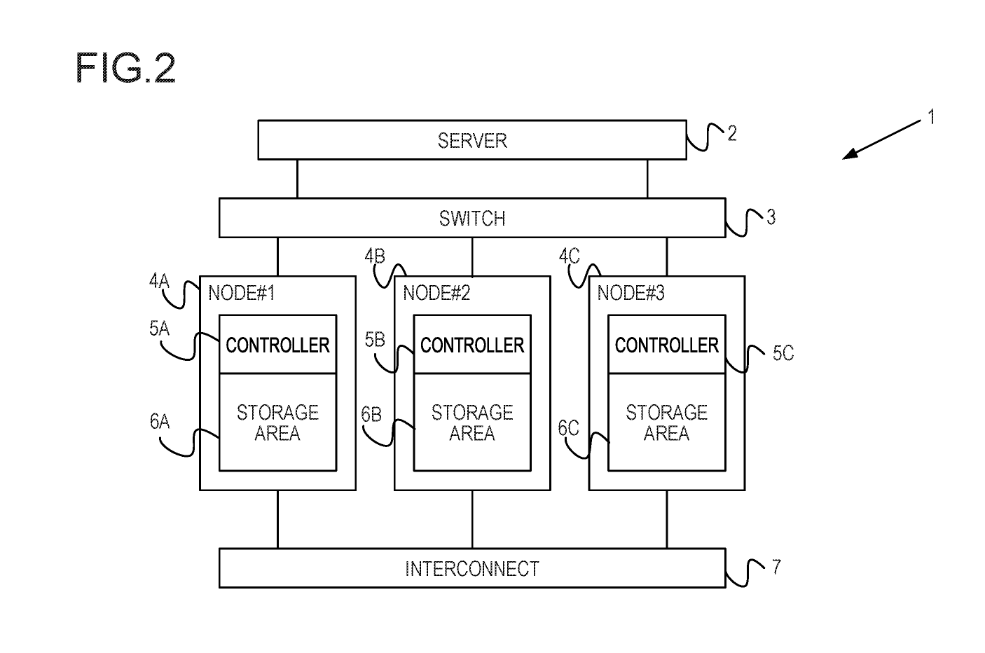

Hereinafter, an embodiment will be described with reference to the accompanying drawings. FIG. 2 illustrates a system 1. The system 1 includes a server 2, a switch 3, nodes 4A to 4C, and an interconnect 7. The system 1 is an example of a storage system.

The server 2 is a host device and performs predetermined processing. The server 2 may be referred to as a business server. The switch 3 switches the communication between the server 2 and the nodes 4A to 4C. The switch 3 may be referred to as a business switch.

In the example of FIG. 2, the node 4A is represented by “node#1”, the node 4B is represented by “node#2”, and the node 4C is represented by “node#3”. Each of the nodes 4A to 4C is an example of a storage apparatus. For example, the storage apparatus is equipped in a storage housing.

The nodes 4A to 4C (also collectively referred to as a node 4) include controllers 5A to 5C (also collectively referred to as a controller 5) and storage areas 6A to 6C (also collectively referred to as a storage area 6), respectively. For example, the controller 5 and the storage area 6 are also equipped in the storage housing described above.

The storage area 6 stores therein data. For example, the storage area 6 is a disk area. The controller 5 performs a control operation of reading/writing of data stored in the storage area 6 or the like. The interconnect 7 is a communication path for connecting the nodes 4 to one another. In the example of FIG. 2, the data stored in each node 4 may be migrated to another node 4 via the switch 3 or the interconnect 7.

The storage apparatus illustrated in FIG. 2 is a virtual storage apparatus. The virtual storage apparatus is a storage apparatus which may realize a free capacity and configuration without being bound by a disk configuration or capacity of a physical storage apparatus. The storage apparatus includes therein an actual storage apparatus (hereinafter, also referred to as a storage unit (SU)), and may generate a virtual volume by a processor device (hereinafter, also referred to as a processor unit (PU)) configured to collectively manage disk areas of the SU as a pool. The controller 5 is an example of the PU. The storage area 6 is an example of the SU.

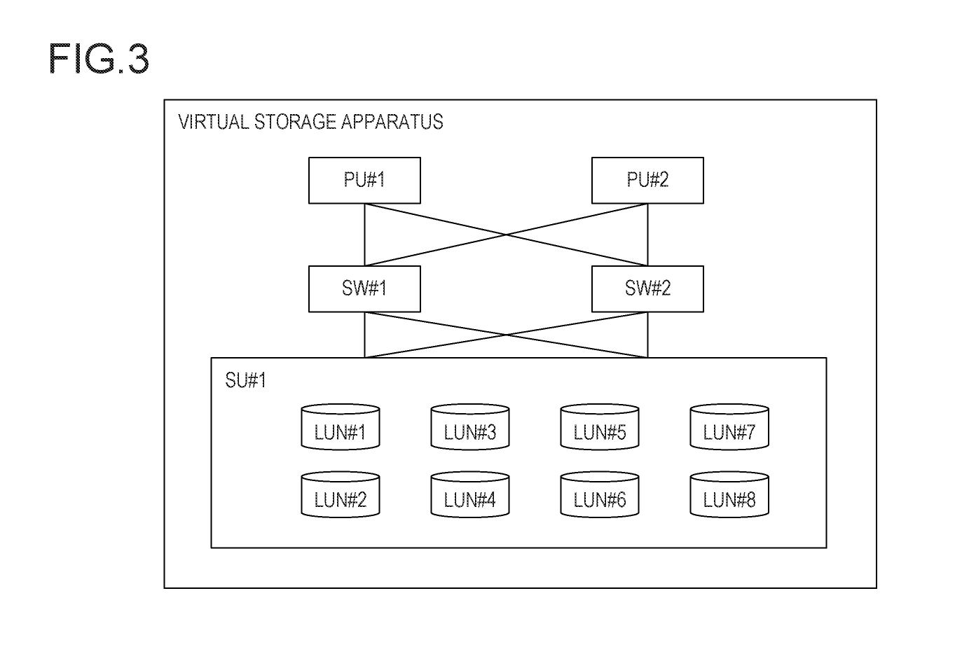

FIG. 3 illustrates an exemplary physical configuration of a virtual storage apparatus. The virtual storage apparatus includes a PU (PU#1, PU#2), a SW (SW#1, SW#2), and an SU (SU#1). Each PU is connected to the SU via each SW. The SU includes a plurality of storage apparatuses (hereinafter, also simply referred to as LUNs) identified by a logical unit number (LUN). The PU executes virtualization software to allow a business server to recognize a virtual disk. Hereinafter, for convenience, a function realized by executing the virtualization software may also be referred to as virtualization software. The virtualization software controls input/output for an actual storage apparatus by appropriately associating or converting an input/output request for the virtual disk with or to an input/output request for the actual storage apparatus.

The system 1 illustrated in FIG. 2 employs a form of the scale-out storage. The scale-out storage is an apparatus that may perform a scaling-out in units of nodes including a set of a PU and an SU. By employing the scaling-out, it is possible to solve the problems related to a capacity shortage or a lack of processing performance.

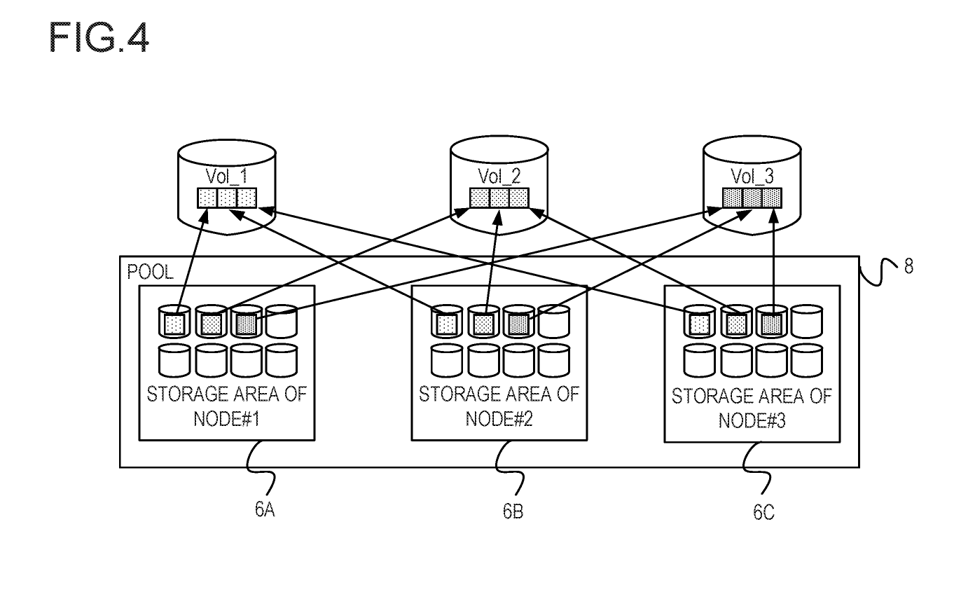

FIG. 4 illustrates an exemplary configuration of scale-out storage. As illustrated in the example of FIG. 4, in the scale-out storage, the storage areas 6 of the respective nodes 4 are collectively managed as a pool 8. Accordingly, even if the respective nodes 4 are separated, a user may handle the storage areas 6 of the nodes 4 as a single virtual storage area.

Each node 4 manages data in units of volumes. The volume may be referred to as a logical volume. In the embodiment, a volume itself is data, and the volume is divided into a plurality of segments. The segment is an example of a data piece.

In the embodiment, the data is considered to correspond to a volume and the data piece is considered to correspond to a segment, but the data is not limited to the volume. Also, the data piece is not limited to the segment. The data may be any information, and the data piece may be information obtained by dividing the data. A storage area in which data is stored may also be referred to as a volume, and a storage area in which a data piece is stored may also be referred to as a segment.

FIG. 4 illustrates an example of a case where a volume for which input/output is controlled by the node 4A is referred as “Vol_1”, a volume for which input/output is controlled by the node 4B is referred as “Vol_2”, and a volume for which input/output is controlled by the node 4C is referred as “Vol_3”.

The segments obtained by dividing volumes for which input/output is controlled by respective nodes 4 are distributively arranged in the storage areas 6 of the nodes 4. This distributive arrangement may be referred to as a wide-striping. In the wide-striping, the segments are distributively arranged in the plurality of nodes 4 so as to suppress input/output loads from being unevenly distributed on one node 4. By performing the wide-striping, the system 1 may exhibit a stable performance.

In the example of FIG. 4, a volume for which input/output is controlled by each node 4 is divided into three segments. The three segments are distributively arranged in the three nodes 4, respectively. Accordingly, the three divided segments may be uniformly and distributively arranged. The volume may be divided into any number of segments. FIG. 4 illustrates an example in which the storage areas 6 of the respective nodes 4 are included in the same pool 8, but the storage areas 6 of some nodes 4 may be included in another pool.

For example, in FIG. 4, if the capacity of eight LUNs included in each node is 1 TB, the virtual storage apparatus may be configured by 240 of 100 GB-volumes, two of 12 TB-volumes, or the like. In this manner, the virtual storage apparatus may realize a free capacity and configuration without being bound by a volume configuration or capacity of a physical storage apparatus.

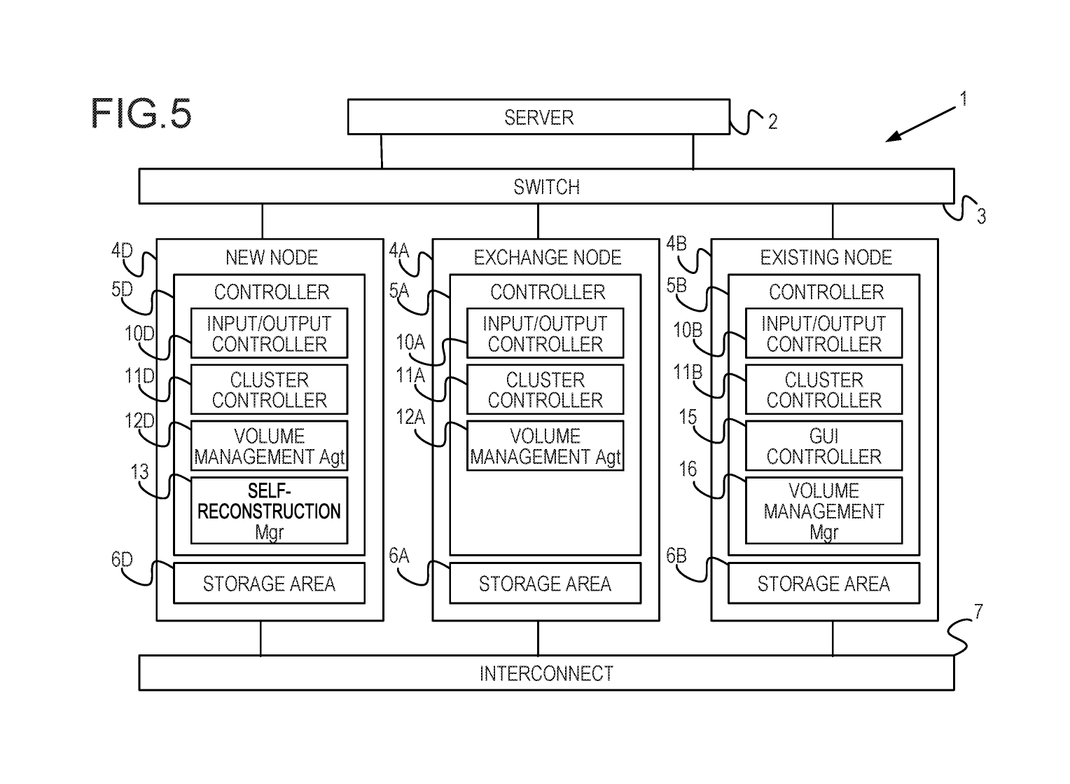

FIG. 5 illustrates an example of the system 1 to which a new node is added. In the embodiment, three kinds of nodes 4 are included in the system 1 as illustrated in FIG. 5. An exchange node 4A is a node to be exchanged.

An existing node 4B is a node not to be exchanged among the nodes 4 currently operated in the existing system 1. In the above-described example of the wide-striping, the segments are distributively arranged in the exchange node 4A and one or more existing nodes 4.

In the example illustrated in FIG. 5, one existing node 4B is present, but, for example, the node 4C illustrated in FIG. 2 may also be an existing node. The number of existing nodes is not limited to one or two. A new node 4D is a node to be newly added. The exchange node 4A is exchanged with the new node 4D.

A controller 5A of the exchange node 4A will be described. The controller 5A includes an input/output controller 10A, a cluster controller 11A, and a volume management agent 12A. Hereinafter, in the drawings, the volume management agent will be referred to as a “VOLUME MANAGEMENT Agt”.

The input/output controller 10A performs a data input/output control for the exchange node 4A.

The cluster controller 11A performs a control on a clustering among a plurality of nodes. In the system 1, some or all of the plurality of nodes 4 may take a redundant configuration (a clustered configuration). The volume management agent 12A manages a volume.

A controller 5B of the existing node 4B will be described. The controller 5B includes an input/output controller 10B, a cluster controller 11B, a graphical user interface (GUI) controller 15, and a volume management manager 16. Hereinafter, in the drawings, the volume management manager will be referred to as a “VOLUME MANAGEMENT Mgr”.

The input/output controller 10B performs a data input/output control for the existing node 4B. The cluster controller 11B performs a control on a clustering among a plurality of nodes. The GUI controller 15 performs a control of a GUI. The volume management manager 16 performs a management of the segments distributively arranged in the exchange node 4A and the existing node 4B.

Here, an example of the volume management manager 16 based on the wide-striping will be described.

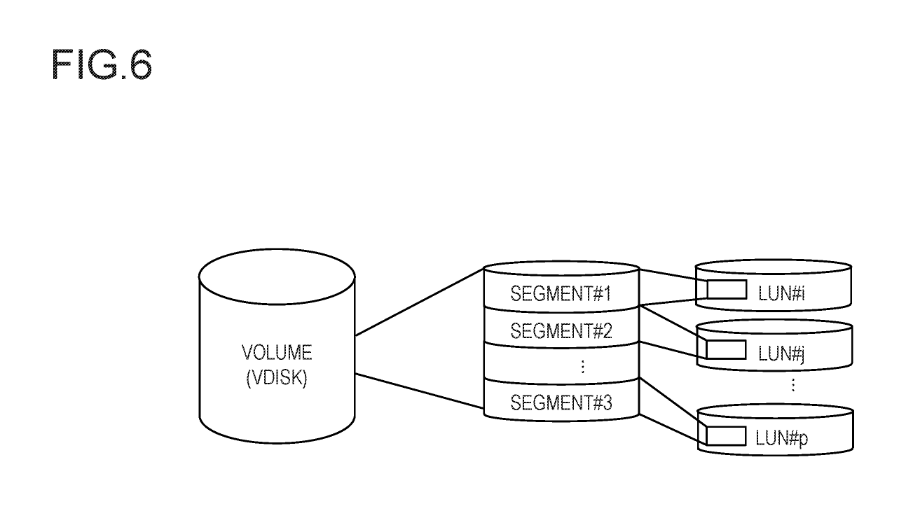

FIG. 6 illustrates an example of the wide-striping. As illustrated in FIG. 6, a volume is divided into a plurality of segments. The divided segments are distributively arranged in a plurality of LUNs. In the embodiment, a LUN corresponds to a storage apparatus.

For example, in a case where one volume is divided into four segments and when one segment is 256 MB, one volume becomes 1024 MB. In the embodiment, the size of each segment is assumed to be a predetermined fixed size.

The volume management manager 16 has distributive arrangement information. The distributive arrangement information is information indicating LUNs in which respective segments of each volume are stored, and storage areas in the respective LUNs. The distributive arrangement information is stored in a predetermined storage area.

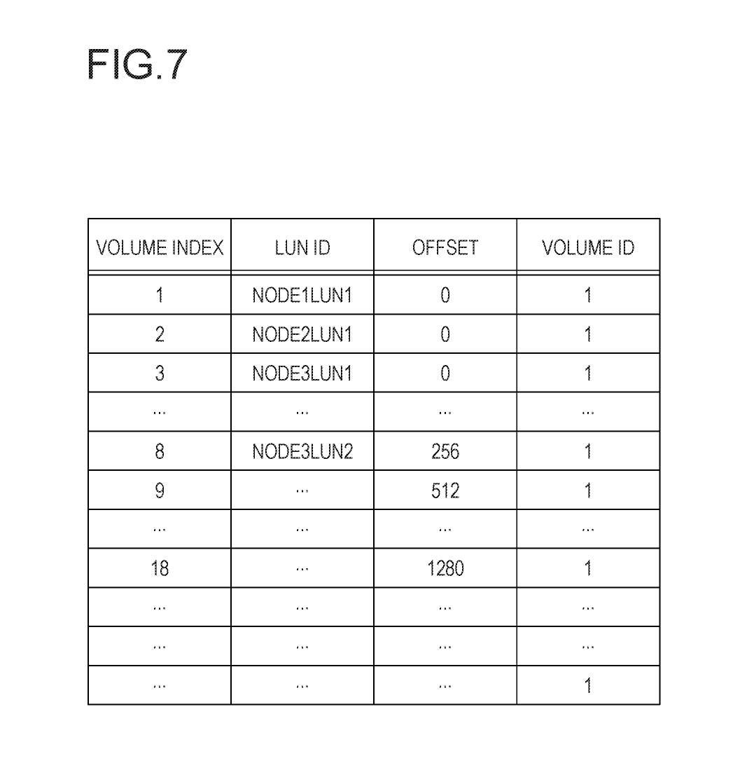

FIG. 7 is an example of the distributive arrangement information managed by the volume management manager 16. In FIG. 7, the distributive arrangement information includes data items of “volume index”, “LUN identifier (ID)”, “offset”, and “volume ID”. Each data item is associated with each record (row). The “volume index” refers to an index number indicating a position of a segment in a volume. That is, the “volume index” indicates that an element corresponding to a segment is placed in which order in the volume. The “LUN ID” indicates an identification number of a LUN in which a corresponding segment is stored. The “offset” indicates an offset within a LUN of an area in which a corresponding segment is stored. The “volume ID” indicates an identification number of a volume.

The example of FIG. 7 illustrates a data structure on a volume (referred to as a volume A) with “volume ID” of “1”. The volume A includes segments stored in a plurality of LUNs of a plurality of nodes. For example, it is indicated that the first segment of the volume A is stored in an area with addresses 0 to 255 in LUN1 of NODE1. It is indicated that the second segment of the volume A is stored in an area with addresses 0 to 255 in LUN1 of NODE2.

As illustrated in FIG. 5, a controller 5D of the new node 4D includes an input/output controller 10D, a cluster controller 11D, a volume management agent 12D, and a self-reconstruction manager 13. The input/output controller 10D performs a data input/output control for the new node 4D. The cluster controller 11D performs a control on a clustering among a plurality of nodes. The volume management agent 12D manages a volume.

The self-reconstruction manager 13 performs a control on a self-reconstruction. The self-reconstruction manager 13 is an example of the storage control device 101.

The self-reconstruction will be described. The self-reconstruction indicates that in a currently operated system 1 using a plurality of nodes 4, for example, a node 4 approaching a maintenance deadline is exchanged with a new node 4. It is required that this exchange is performed online, that is, without stopping the operation of a business server. In the exchange, data of a node to be exchanged is migrated to a new node.

When the self-reconstruction is performed online, whole data updated during the data migration is also migrated to an exchange destination node. In order to realize this, the data update of a volume to be exchanged is managed in units of segments of a volume, and processing of, for example, copying again an area updated after first copying is performed.

In the scale-out storage, a volume includes a plural pieces of data distributively arranged in disk areas of a plurality of nodes. When such a volume including distributively arranged data is migrated, a management or control on data over the plurality of nodes is performed.

Actual data is unable to be distributively arranged over incompatible nodes. This is because an independent pool management is performed for each node group in a case where, for example, virtualization software or an interconnect is varied due to a difference in generations of storage apparatus between an existing node group and a new node group. Accordingly, in a case where there is no compatibility between a new node and an existing node, the volume is disabled when the data is distributively arranged in the new node and the existing node or an exchange node at a certain point of time during migration, and thus the business is stopped.

From these, it is preferable that the data migration is collectively performed from one migration origin node in units of volumes. Accordingly, in the embodiment, the self-reconstruction manager 13 first performs a control operation prior to migration such that the segments which have been distributively arranged in respective nodes are collectively arranged in an exchange node. Then, the self-reconstruction manager 13 performs a control operation such that the segments of a volume to be migrated, which have been collected in the exchange node, are to be collectively migrated in units of volumes.

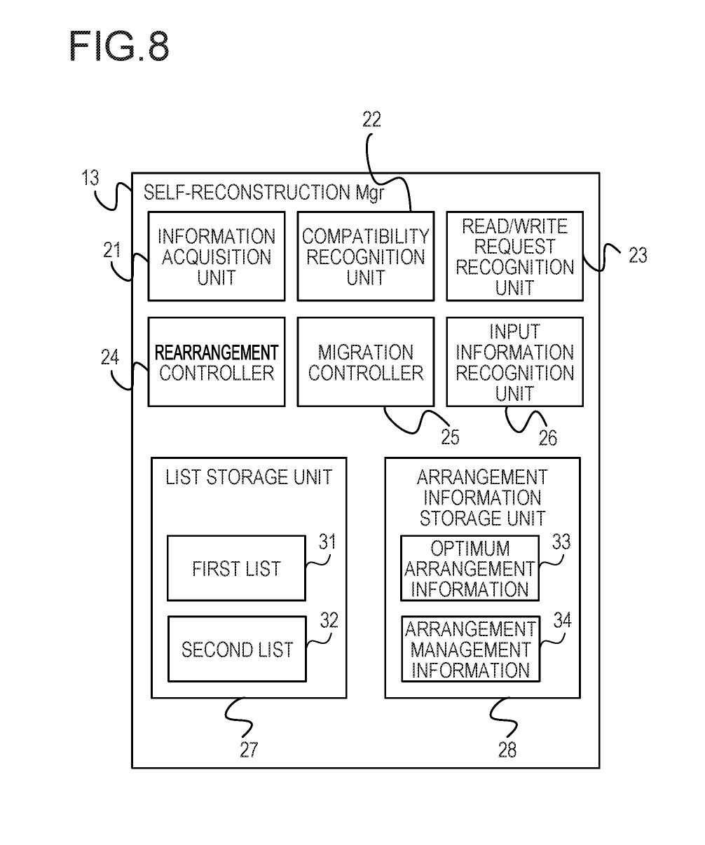

In the example of FIG. 5, the self-reconstruction manager 13 configured to control the self-reconstruction is included in the controller 5D of the new node 4D. FIG. 8 illustrates an exemplary functional configuration of the self-reconstruction manager 13. In the drawings, the self-reconstruction manager may be referred to as a “SELF-RECONSTRUCTION Mgr”.

The self-reconstruction manager 13 in the example of the FIG. 8 includes an information acquisition unit 21, a compatibility recognition unit 22, a read/write request recognition unit 23, a rearrangement controller 24, a migration controller 25, an input information recognition unit 26, a list storage unit 27, and an arrangement information storage unit 28.

The information acquisition unit 21 acquires distributive arrangement information from the volume management manager 16 of the existing node 4B. For example, the information acquisition unit 21 acquires the distributive arrangement information from the existing node 4B via the switch 3 or the interconnect 7 using a communication function of the new node 4D.

The compatibility recognition unit 22 recognizes the compatibility of the interconnect 7. The compatibility recognition unit 22 may perform a communication with a node 4 connected to a compatible interconnect 7. The read/write request recognition unit 23 recognizes that the server 2 has issued a read request or a write request to the input/output controller 10D.

The rearrangement controller 24 performs rearrangement of respective segments subjected to the wide-striping. A volume (Vol_1: hereinafter, referred to as a volume V1) of the exchange node 4A is distributively arranged in the exchange node 4A and one or more existing nodes. The rearrangement controller 24 performs a control operation such that segments (obtained by dividing the volume V1) of the volume V1 are to be rearranged in a storage area 6A of the exchange node 4A. The rearrangement controller 24 performs a control operation such that segments of a volume other than the migration target, which are arranged in the exchange node 4A, are to be arranged in other one or more nodes 4. Specifically, the rearrangement controller 24 transmits an instruction to the volume management manager 16 of the controller 5B, and the volume management manager 16 which has received the instruction controls the data rearrangement. The volume management manager 16 transmits a rearrangement instruction to the volume management agent 12A of the controller 5A, in accordance with the received instruction. Then, the volume management agent 12A which has received the rearrangement instruction performs a rearrangement operation in order to control the rearrangement of the segments of the exchange node 4A. The rearrangement controller 24 performs a control operation such that segments of a volume arranged in the exchange node 4A are to be arranged in other one or more nodes 4. The rearrangement controller 24 performs the wide-striping.

The migration controller 25 migrates the input/output controller 10A of the exchange node 4A to the input/output controller 10D of the new node 4D. For example, the migration controller 25 may copy the input/output controller 10A to the input/output controller 10D. Here, for example, an address (for example, a virtual Internet protocol (IP) address) that has been assigned to the exchange node 4A may also be migrated to the new node 4D. Accordingly, a node responsible for the volume V1 is changed from the exchange node 4A to the new node 4D. The migration controller 25 is an example of the migration unit 104.

After migrating the input/output controller 10A, the migration controller 25 migrates the segments of the volume V1 stored in the storage area 6A of the exchange node 4A to the new node 4D. That is, the migration controller 25 migrates the volume V1 from the exchange node 4A to the new node 4D.

The input information recognition unit 26 recognizes input information. For example, when a user inputs information using an input unit (not illustrated) provided in a computer (not illustrated) which manages the new node 4D or the system 1, the information input by the user is recognized by the input information recognition unit 26.

The list storage unit 27 stores therein a first list 31 and a second list 32. The first list 31 is a list of volumes to be migrated. The second list 32 is a list of volumes other than a migration target, which are not to be migrated. Identification information of the volumes to be migrated, which are included in the first list 31, may be input from a user via the input information recognition unit 26. Identification information of the volumes other than the migration target, which are included in the second list 32, may be input from the user via the input information recognition unit 26.

The arrangement information storage unit 28 stores therein optimum arrangement information 33 and arrangement management information 34. Each of the optimum arrangement information 33 and the arrangement management information 34 is information used for the rearrangement processing performed by the rearrangement controller 24. The optimum arrangement information 33 is information indicating a layout of the segments stored in the storage area of the exchange node, and indicating an optimum layout (arrangement) for migration. Specifically, the optimum arrangement indicates, for example, a state where the segments are consecutively arranged in order of volume index from one end of a predetermined area in the storage area of the exchange node. The arrangement management information 34 is information indicating the segments stored in the storage area of the exchange node. Details of the optimum arrangement information 33 and the arrangement management information 34 will be described later.

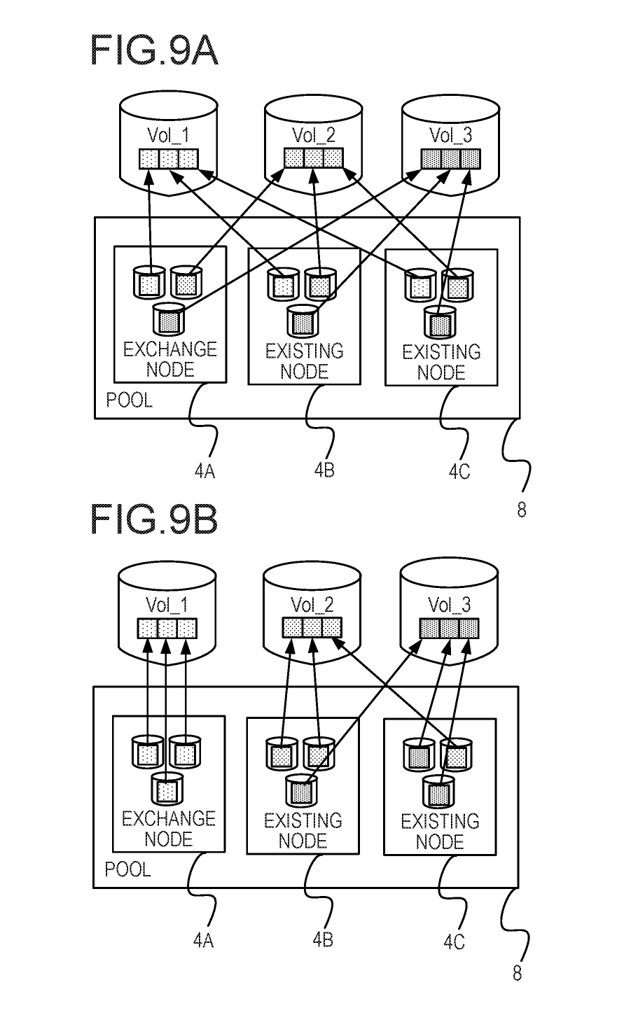

FIGS. 9A and 9B illustrate an example of volume rearrangement. As illustrated in FIG. 9A, there is a volume V1 associated with an exchange node 4A. There is a volume (Vol_2: hereinafter, referred to as a volume V2) associated with an existing node 4B. There is a volume (Vol_3: hereinafter, referred to as a volume V3) associated with an existing node 4C.

Each of the volumes V1, V2 and V3 is divided into a plurality of segments which are uniformly and distributively arranged in the respective nodes 4. The information acquisition unit 21 acquires the distributive arrangement information from the volume management manager 16 of the existing node 4B.

Accordingly, the rearrangement controller 24 may recognize information on the volume segments which are distributively arranged in the exchange node 4A and the existing nodes 4B and 4C. The rearrangement controller 24 performs a control operation such that the segments of the volume V1 are to be rearranged in the exchange node 4A on the basis of the distributive arrangement information.

The rearrangement controller 24 performs, on the basis of the distributive arrangement information, a control operation such that the segments of the volumes V2 and V3 other than the volume V1, which are arranged in the exchange node 4A, are to be rearranged in the existing node 4B or 4C.

FIG. 9B illustrates a state of segments rearranged in the respective node 4 after the rearrangement controller 24 has performed the rearrangement of the segments. As illustrated in FIG. 9B, all segments of the volume V1 are rearranged in the exchange node 4A.

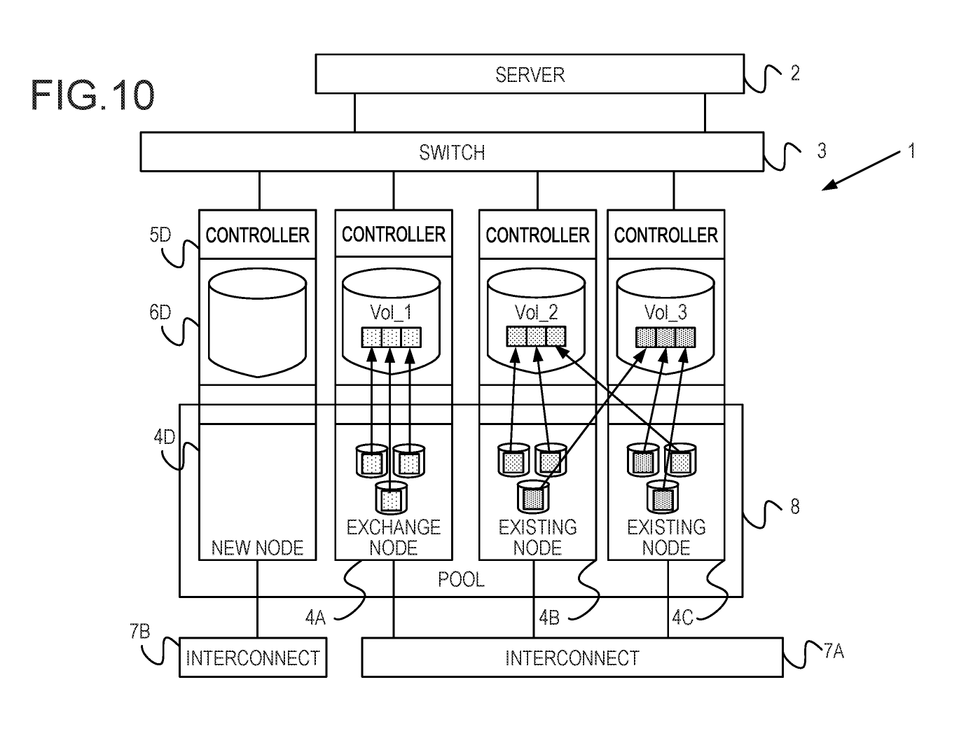

FIG. 10 illustrates an example of the entire system 1 after the segment rearrangement has been performed as in FIG. 9B. As illustrated in FIGS. 9B and 10, the exchange node 4A stores therein the segments of only the volume V1.

The rearrangement controller 24 may rearrange the segments of any one or more volumes, in the exchange node 4A. For example, when many segments of the volume V2 are arranged in the exchange node 4A, the rearrangement controller 24 may rearrange the segments of the volume V2 in the exchange node 4A from the existing node 4B or 4C.

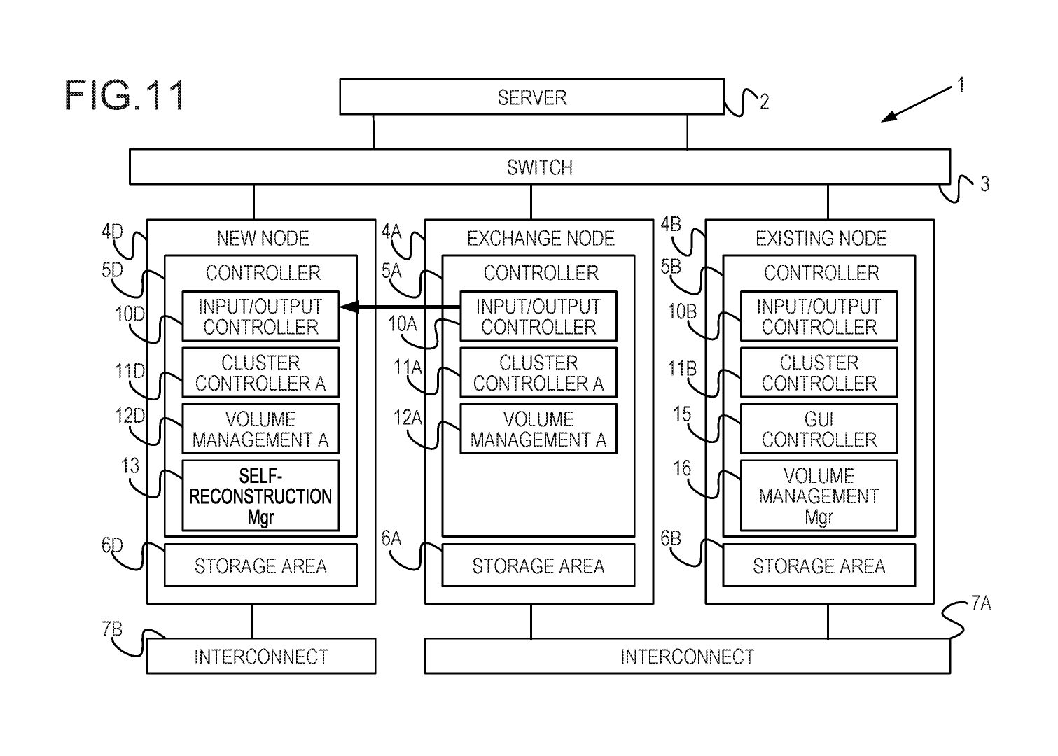

Hereinafter, an example of volume migration will be described with reference to FIGS. 11 to 13. FIGS. 11 to 13 are diagrams illustrating the volume migration. As described above, the rearrangement controller 24 performs rearrangement of the segments of a volume from one or more existing nodes 4 to a node 4 to be exchanged. Hereinafter, it is assumed that the node 4 to be exchanged is an exchange node 4A, and one or more existing nodes 4 are existing nodes 4B and 4C.

By performing the rearrangement of the segments of a volume by the rearrangement controller 24, the volume is rearranged in the storage area 6A of the exchange node 4A. The volume is considered as the above-described volume V1.

As illustrated in FIG. 11, the migration controller 25 migrates the input/output controller 10A of the exchange node 4A to the new node 4D. For example, the migration controller 25 copies the function of the input/output controller 10A to the input/output controller 10D of the new node 4D. Accordingly, a node responsible for the volume V1 is changed from the exchange node 4A to the new node 4D.

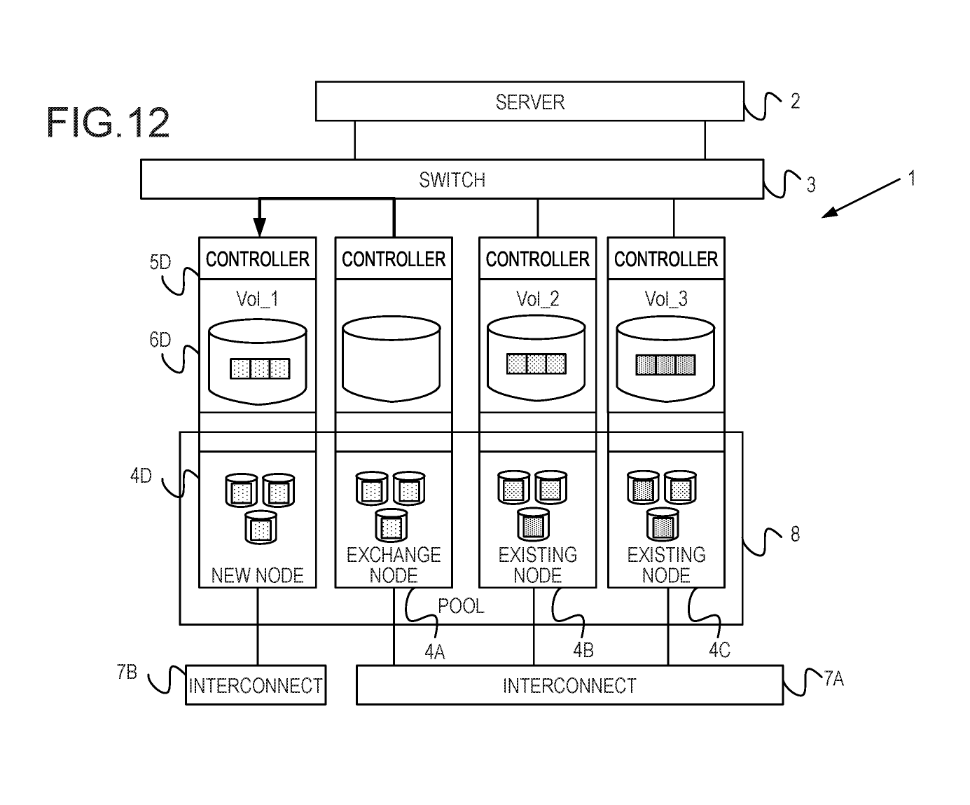

Then, as illustrated in FIG. 12, the migration controller 25 migrates the volume V1 rearranged in the storage area 6A of the exchange node 4A to a storage area 6D of the new node 4D via the switch 3. The migration may be performed via the interconnects when there is compatibility between an interconnect 7A and an interconnect 7B, and the exchange node 4A and the new node 4D may communicate with each other via the interconnects.

As described above, when the migration controller 25 migrates the input/output controller 10A of the exchange node 4A to the new node 4D, a node responsible for the volume V1 to be migrated becomes the new node 4D. Then, the migration controller 25 migrates the volume V1 from the exchange node 4A to the new node 4D, and thus, a node exchange operation may be performed while maintaining the continuity in the operation of the system 1. Furthermore, it becomes possible to exchange nodes without changing the setting in the server 2.

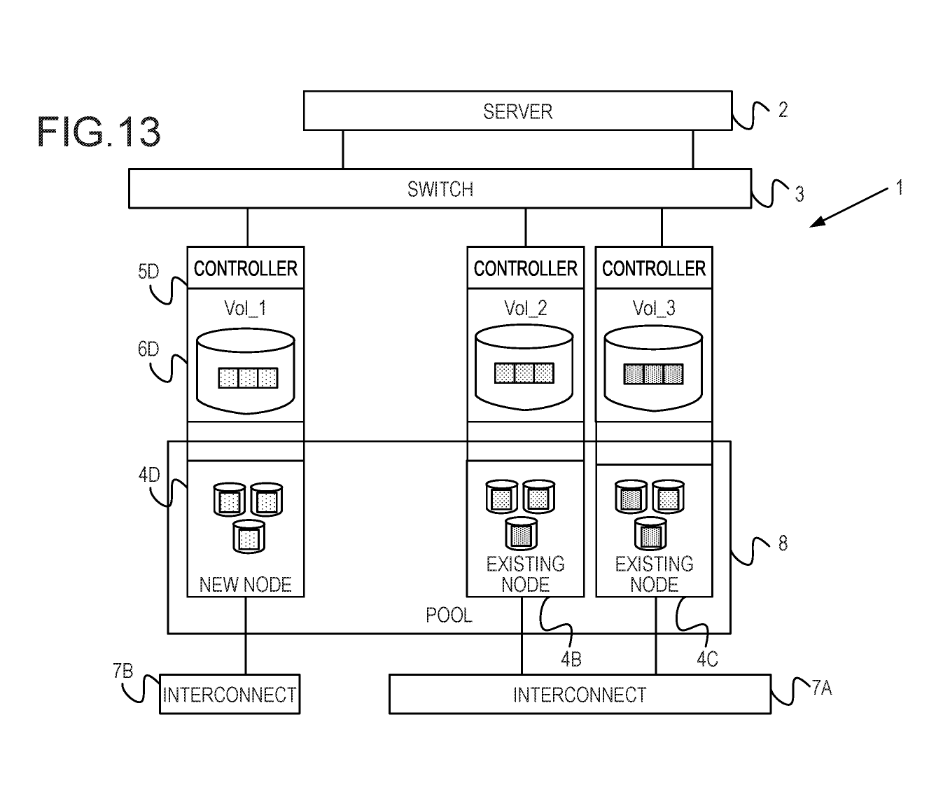

FIG. 13 illustrates a state where the migration controller 25 has separated the exchange node 4A from the system 1. The node responsible for the volume V1 has been changed from the exchange node 4A to the new node 4D. The volume V1 has been migrated to the storage area 6D of the new node 4D.

As described above, the rearrangement controller 24 rearranges, in the exchange node 4A, the segments of the volume V1, which have been distributively arranged in the exchange node 4A and the existing nodes 4B and 4C. Then, the migration controller 25 migrates the volume V1 from the exchange node 4A to the new node 4D. Accordingly, the migration controller 25 may migrate the segments of the volume V1 which are collected in the exchange node 4A, as they are, to the new node 4D, and thus may perform efficient data migration. The migration controller 25 performs the migration of the volume V1 after migrating the input/output controller 10A of the exchange node 4A to the new node 4D. Accordingly, it is possible to perform data migration while continuing the operation of the system 1.

When the volume to be migrated has a large capacity, an area of the exchange node in which a large capacity volume is to be stored may be unable to be secured during the rearrangement. In this case, since the rearrangement of the volume to be migrated is not performed, it is impossible to collectively migrate data with a large capacity volume. This corresponds to a case where, for example, in FIGS. 9A and 9B, the capacity of the volume V1 to be migrated is larger than the storage area 6A of the exchange node 4A.

Thus, when the volume to be migrated has a large capacity, it is also considered to perform migration in units of segments. However, in the migration in units of segments, copying is performed while managing and updating a large amount of segments, and thus, the efficiency of the migration is deteriorated.

When there is no compatibility in the standard (for example, Ethernet (registered trademark), Infiniband, or the like) between an interconnect used by a new node and an interconnect used by an existing node, a message communication or data migration is performed via a network (hereinafter, also referred to as a business network) to which the switch 3 belongs. In this case, in the business network, a large number of communication messages for migration and actual data are exchanged. Here, in the business network, data is also communicated by business input/output (I/O) from the server 2. Thus, performing migration via the business network may affect the business.

In the embodiment, in order to cope with migration in such a case where a volume to be migrated has a large capacity, data migration is performed by collecting the segments of the volume to be migrated per the total number (hereinafter, also referred to as an arrangement number) of segments arrangeable in the exchange node. Here, a segment group collected at once is a segment group in which the positions (hereinafter, also referred to as volume indices) of the segments are consecutive in a volume. The order in which such a segment group is migrated is controlled depending on the position of the segment group in the volume. When the data migration is collectively performed per the arrangement number, efficient data migration becomes possible even for a large capacity volume. Accordingly, the load applied to the business network during the data migration may be reduced.

In the embodiment, the rearrangement of the segments is properly controlled such that the volume segments to be migrated are collected in units of segment groups of the arrangement number and migrated. Specifically, in the rearrangement processing, the rearrangement controller 24 performs rearrangement processing for collecting a segment group collected per the arrangement number in the storage area 6A of the exchange node using the optimum arrangement information 33 and the arrangement management information 34. Here, the rearrangement controller 24 performs rearrangement processing such that a layout of a storage area after the rearrangement is placed in a state where segments are consecutively arranged in order of volume index from one end of the storage area.

In such rearrangement processing performed such that the segments are consecutively arranged in order of volume index from one end of the storage area, copying of the segments is likely to occur frequently. Accordingly, the rearrangement controller 24 according to the embodiment performs rearrangement of data while suppressing the number of times of copying the segments.

Hereinafter, the rearrangement controller 24 according to the present embodiment will be described in detail.

In the rearrangement processing, when data is exchanged between nodes, a wasteful cost occurs to that extent. Therefore, the rearrangement controller 24 performs a control operation such that the segments of a volume to be migrated, which have been present within the exchange node since before the rearrangement processing, are not expelled to another existing node.

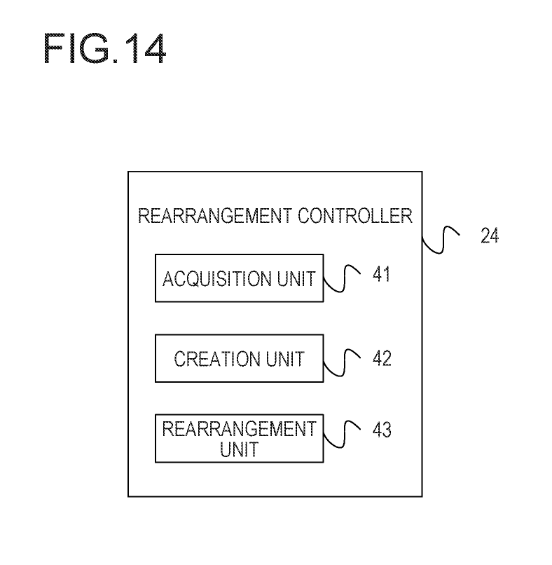

FIG. 14 illustrates an exemplary functional configuration of the rearrangement controller 24. The rearrangement controller 24 includes an acquisition unit 41, a creation unit 42, and a rearrangement unit 43. The acquisition unit 41 acquires distributive arrangement information from the information acquisition unit 21. The acquisition unit 41 acquires the first list 31 and the second list 32 from the list storage unit 27. The creation unit 42 creates the arrangement management information 34 on the basis of the distributive arrangement information. The creation unit 42 creates the optimum arrangement information 33 on the basis of the number of the segments of a volume to be migrated and an arrangement number. The rearrangement unit 43 performs rearrangement of the segments using the optimum arrangement information 33 and the arrangement management information 34. The acquisition unit 41 is an example of the reception unit 102. The creation unit 42 is an example of the determination unit 103. The rearrangement unit 43 is an example of the migration unit 104.

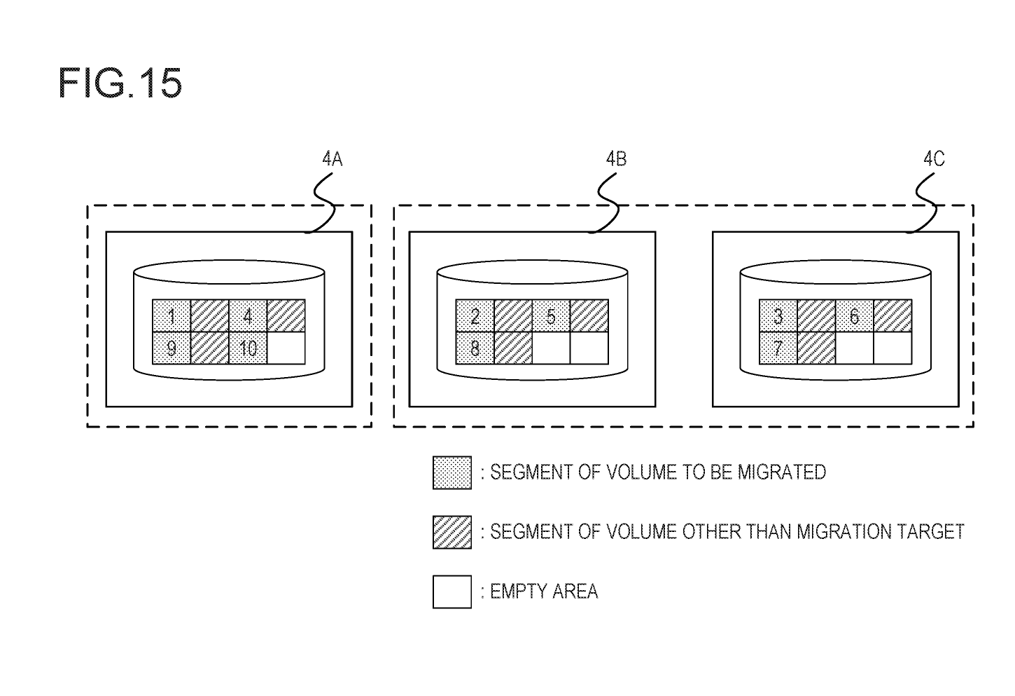

Hereinafter, details of the rearrangement processing adjusted for migration of a large capacity volume will be described with reference to FIGS. 15 to 20. In the description with reference to FIGS. 15 to 20, a volume to be migrated is set as a volume A (volume ID is “1”), and a volume other than the migration target is set as a volume D (volume ID is “D”).

FIG. 15 illustrates an example of an arrangement of the segments before the rearrangement processing. In FIG. 15, the segments of a volume to be migrated and the segments of a volume other than a migration target are distributively arranged in the storage areas of the respective nodes 4A to 4C. The storage area of the node 4A to be migrated includes eight divided areas. The eight divided areas are identified by node indices. In FIG. 15, it is assumed that the node indices, “1”, “2”, “3”, and “4”, are sequentially set from the divided area at the upper left side to the divided area at the upper right side, and the node indices, “5”, “6”, “7”, and “8” are sequentially set from the divided area at the lower left side to the divided area at the lower right side. It is also assumed that the areas with consecutive node indices are physically consecutive. That is, it is assumed that the divided areas with node indices “4” and “5” are physically consecutive. The size of each divided area is a segment size. In FIG. 15, a number allocated to a segment of a migration volume A indicates a value of a volume index. That is, the migration volume A is a volume including the segments of volume indices of “1” to “10”. Accordingly, the example of FIG. 15 illustrates an example in which the migration volume A is unable to be completely stored at once in the storage areas of the exchange node 4A. Hereinafter, a process of performing rearrangement of data from the state illustrated FIG. 15 will be described as an example.

First, the acquisition unit 41 acquires the first list 31 and the second list 32 from the list storage unit 27. The creation unit 42 and the rearrangement unit 43 acquire, from the first list 31, identification information of volumes to be migrated. The creation unit 42 and the rearrangement unit 43 acquire identification information of volumes other than a migration target from the second list 32.

Then, the acquisition unit 41 acquires the distributive arrangement information from the information acquisition unit 21. On the basis of the distributive arrangement information, the creation unit 42 creates the arrangement management information 34. The arrangement management information 34 is information indicating an arrangement of the segments currently stored in the storage area 6A of the exchange node 4A.

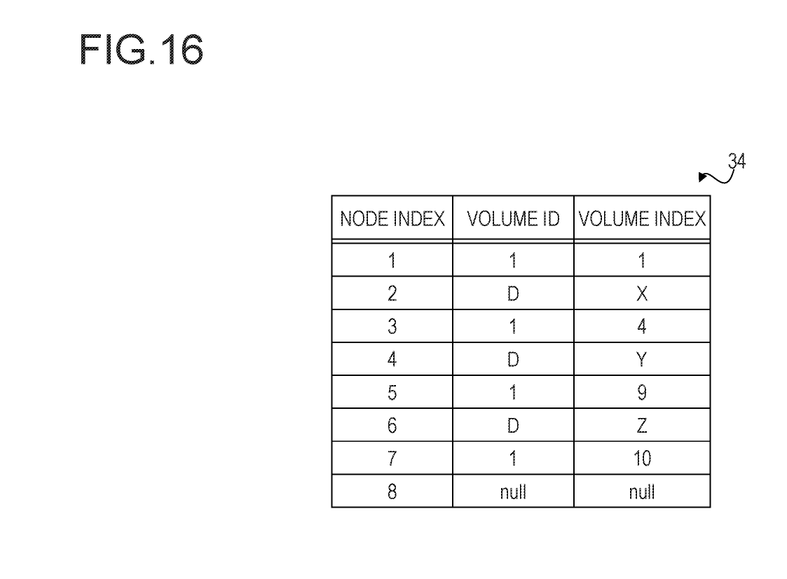

FIG. 16 illustrates an exemplary data structure of the arrangement management information 34. In FIG. 16, the arrangement management information 34 includes data items of “node index”, “volume ID”, and “volume index”. These data items are associated with one another in each record (row).

The “node index” refers to identification information of each divided area obtained by dividing the storage area 6A of the exchange node 4A in each segment size. The divided areas with consecutive node indices indicate that their physical areas are consecutive. The “volume ID” refers to an identification number of a volume to which a segment stored in the divided area indicated by the corresponding “node index” belongs. The “volume index” refers to an index number indicating a position, in the volume, of the segment stored in the divided area indicated by the corresponding “node index”. That is, the “volume index” indicates that an element corresponding to the segment is placed in which order in the volume.

The arrangement management information 34 illustrated in FIG. 16 illustrates an arrangement of the segments of the exchange node 4A illustrated in FIG. 15. For example, the first record of the arrangement management information 34 indicates that a segment with “volume index” indicated by “1” in a volume with “volume ID” of “1” is stored in a divided area with “node index” of “1” in the exchange node 4A. In the following description, a divided area with “node index” of x (x is a positive integer) may be referred to as divided area_x, and a segment indicated by “volume index” of y (y is a positive integer) may be referred to as segment_y.

Then, the rearrangement controller 24 creates the optimum arrangement information 33 indicating an optimum arrangement of segments after the rearrangement in the storage area 6A of the exchange node 4A. The optimum arrangement indicates a state in which among the segments of a volume to be migrated, which have not yet been migrated, the segments of the same number as an arrangement number or all segments which have not yet been migrated are consecutively arranged in order of volume index from one end of the storage area 6A. When the total number of segments which have not yet been migrated is larger than the arrangement number, the optimum arrangement is placed in a state where the segments of the same number as the arrangement number are consecutively arranged from one end of the storage area 6A. When the total number of segments which have not yet been migrated is equal to or smaller than the arrangement number, the optimum arrangement indicates a state in which all segments which have not yet been migrated are consecutively arranged from one end of the storage area 6A. The rearrangement processing may be repeated several times for segments of the arrangement number, and the optimum arrangement information 33 indicates an optimum arrangement in the rearrangement processing to be performed next.

When there is a plurality of volumes to be migrated, the optimum arrangement is as follows. That is, when the plurality of volumes to be migrated are a volume X and a volume Y, the optimum arrangement is placed in a state where not-yet-migrated segments of the volume X are consecutively arranged in order of volume index from one end of the storage area 6A. Then, the optimum arrangement is placed in a state where the segments of the volume Y are consecutively arranged in order of volume index from a divided area next to a divided area in which the last segment of the volume X is stored.

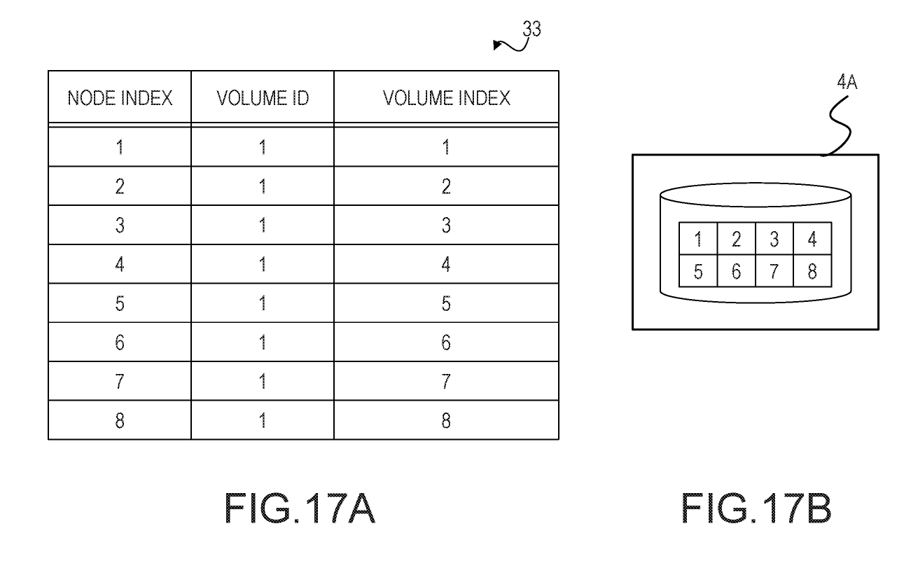

FIGS. 17A and 17B illustrate the optimum arrangement information 33. FIG. 17A illustrates an exemplary data structure of the optimum arrangement information 33. The optimum arrangement information 33 indicates a correspondence relationship between an index within a node and a volume index. In FIG. 17A, the optimum arrangement information 33 includes data items of “node index”, “volume ID”, and “volume index”. These data items are associated with one another in each record (row).

The “node index” refers to identification information of each divided area obtained by dividing the storage area 6A of the exchange node 4A in each segment size. The “volume ID” refers to an identification number of a volume to which a segment to be stored in the divided area indicated by the corresponding “node index” belongs in the optimum layout. The “volume index” refers to an index number of the segment to be stored in the divided area indicated by the corresponding “node index” in the optimum layout.

FIG. 17B is a diagram illustrating a physical arrangement indicated by the optimum arrangement information 33. In the optimum arrangement information 33, all segments stored in the respective divided areas are set as segments belonging to a volume A with “volume ID” of “1”, which is a volume to be migrated. In the divided areas with node indices of “1” to “8”, the segments having “volume index” of “1” to “8”, respectively, are stored. In this manner, the optimum arrangement information 33 of FIG. 17A indicates a state where among not-yet-migrated segments of the volume A, the segments (1 to 8) of the same number as an arrangement number (“8”) are consecutively arranged in an ascending order of volume index from one end of the storage area 6A. In the following description, a divided area with a minimum node index (“1”) is referred to as a front end, and a divided area with a node index equal to the arrangement number is referred to as a rear end.

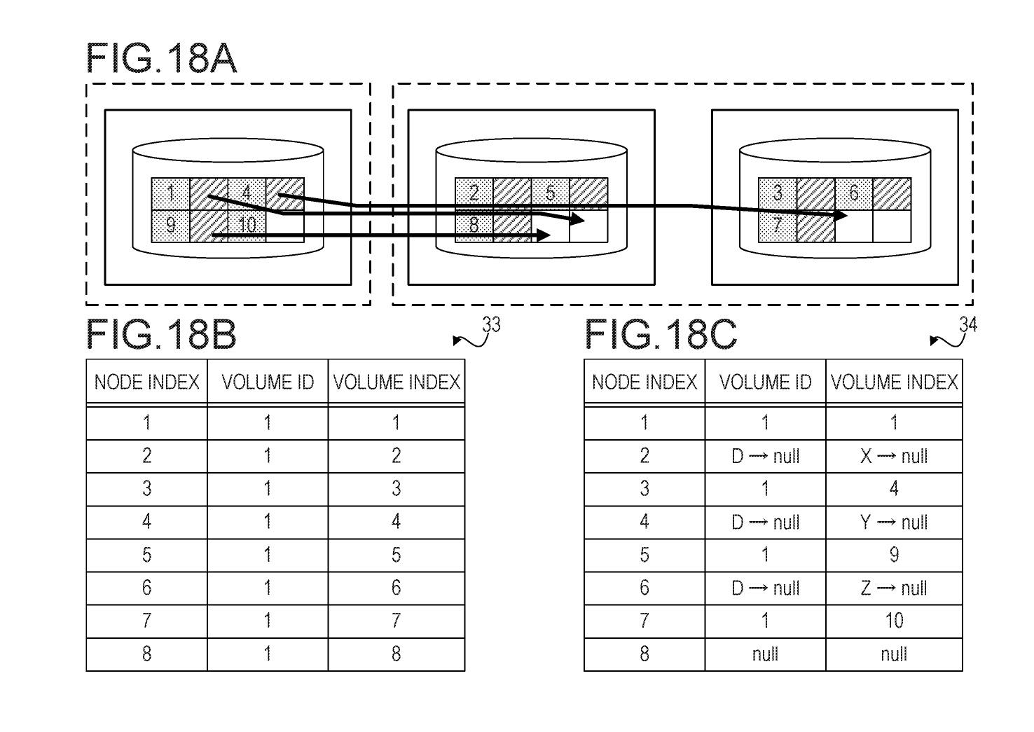

When the creation of the optimum arrangement information 33 is completed, the rearrangement unit 43 expels segments of the volume D other than the migration target from the exchange node 4A to the existing nodes 4B and 4C. FIGS. 18A to 18C illustrate the expulsion of the segments of the volume other than the migration target. FIG. 18A illustrates a state of the expulsion. FIG. 18B illustrates the optimum arrangement information 33 at the time of expulsion. FIG. 18C illustrates a change of the arrangement management information 34 at the time of expulsion.

As illustrated in FIG. 18A, the rearrangement unit 43 rearranges the segments of the volume D stored in the storage area 6A of the exchange node 4A, in empty areas of the existing nodes 4B and 4C. The areas of the storage area 6A in which the expelled segments have been stored become empty areas. The rearrangement unit 43 updates the arrangement management information 34 along with the expulsion.

As illustrated in FIG. 18C, in the arrangement management information 34, each of values of “volume ID” and “volume index” in a record with “volume ID” of “D” has been changed to “null”. A record with a value of “null” is a record indicating an empty area.

It is assumed that a segment for which an expulsion destination in an existing node is unable to be secured is moved to the rear end of the exchange node. Due to the movement, a storage destination of a segment to be stored at the rear end in the optimum arrangement is filled. Thus, the rearrangement unit 43 reflects, in the optimum arrangement information 33, the fact that data movement to the divided area at the rear end has become impossible, and decrements the arrangement number. Accordingly, the rearrangement unit 43 suppresses the segments from being stored in duplicate. However, in many cases, a sufficient margin is present in the total capacity of a virtual volume, and there is only a small probability that a case occurs, in which an expulsion destination in the existing node is unable to be secured.

When the expulsion is completed, the rearrangement unit 43 rearranges the segments of the migration volume A in the exchange node 4A on the basis of the optimum arrangement information 33. That is, the rearrangement unit 43 performs a movement of the volume segments to be migrated so as to satisfy a layout indicated by the optimum arrangement information 33. When the divided area serving as a movement destination is not an empty area, the rearrangement unit 43 temporarily evacuates the segment stored in the corresponding area to a separate empty area of the exchange node 4A. In this evacuation as well, the rearrangement unit 43 determines the evacuation destination so as to satisfy the layout indicated by the optimum arrangement information 33. Specifically, the rearrangement of segments of the migration volume A is performed in the following sequence.

First, the rearrangement unit 43 moves segments which do not completely fit in the exchange node 4A at once, to the rear end of the storage area 6A. That is, the rearrangement unit 43 moves segments dropped from the layout indicated by the optimum arrangement information 33, among the segments of the volume A present in the exchange node 4A, to the rear end of the storage area 6A. Specifically, the rearrangement unit 43 selects the segments of the volume A present in the exchange node 4A in a descending order of the segment volume index, and then repeatedly performs the following relocation processing. That is, the rearrangement unit 43 first determines whether a volume index of the selected segment is different from “volume index” of any of records in the optimum arrangement information 33. When it is determined that the volume index is different, the rearrangement unit 43 moves the selected segment to the rear end of the storage area 6A. Along with the movement of the selected segment, the rearrangement unit 43 updates a value of “volume index” of a record corresponding to the rear end divided area to be the volume index of the moved segment, in the optimum arrangement information 33. The rearrangement unit 43 reflects the state after the movement in the arrangement management information 34. Then, the rearrangement unit 43 decrements (−1) a value of the arrangement number. This relocation processing is repeatedly performed until a volume index of a segment selected in the relocation processing coincides with “volume index” of any of records in the optimum arrangement information 33.

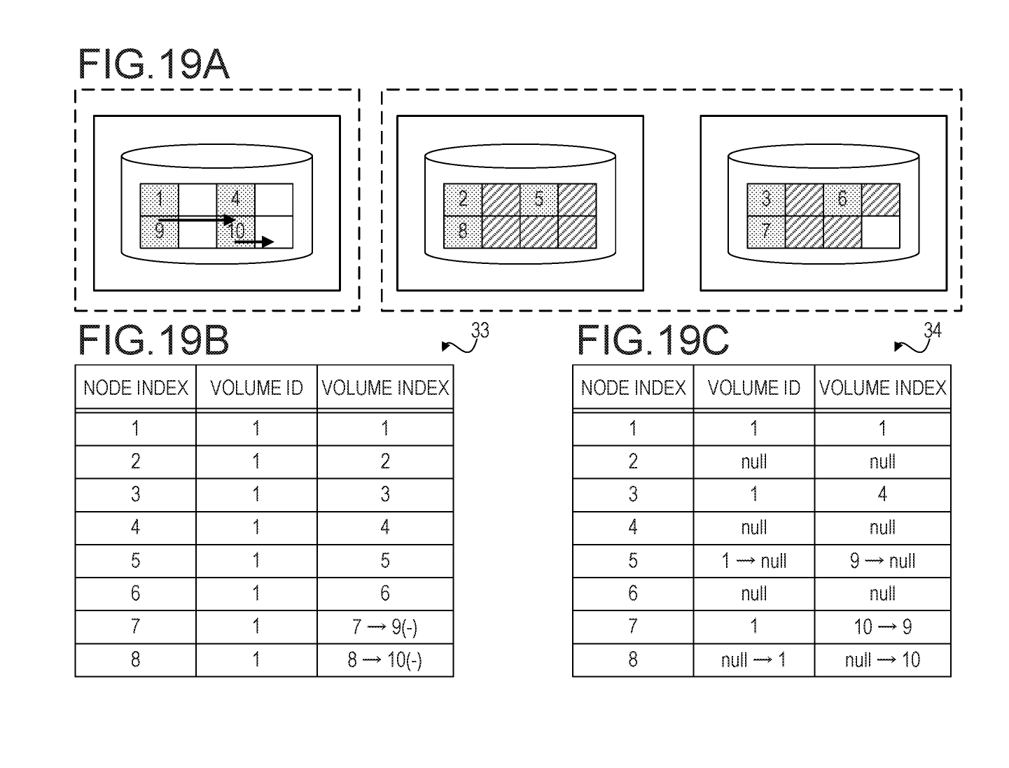

FIGS. 19A to 19C illustrate movement of segments dropped from the layout indicated by the optimum arrangement information 33, to the rear end. FIG. 19A illustrates a state of the movement to the rear end. FIG. 19B illustrates a change of the optimum arrangement information 33 at the time of movement to the rear end. FIG. 19C illustrates a change of the arrangement management information 34 at the time of movement to the rear end.

As illustrated in FIG. 19B, before the movement to the rear end, a value of “volume index” in a record of the optimum arrangement information 33 is any one of “1” to “8”, and the arrangement number is “8”. As illustrated in FIG. 19A, before the movement to the rear end, among the segments of the volume A stored in the storage area 6A, the segments having volume indices different from any of “1” to “8” are segment_9 and segment_10.

Thus, the rearrangement unit 43 first selects segment_10 with the largest volume index. Then, the rearrangement unit 43 determines whether the volume index of segment_10 is different from “volume index” of any of records in the optimum arrangement information 33. Then, the rearrangement unit 43 moves segment_10 to the rear end, that is, divided area_8. Along with this, the rearrangement unit 43 changes the value of “volume index” of a record with “node index” of “8” in the optimum arrangement information 33 to “10”, and changes the value of the arrangement number from “8” to “7”.

Then, the rearrangement unit 43 selects segment_9 with the next largest volume index after “10”. In the same manner as segment_10, for segment_9, the rearrangement unit 43 performs a movement operation to the rear end, and a change of the optimum arrangement information 33 and the arrangement number.

As described above, the rearrangement unit 43 moves the segments dropped from the layout indicated by the optimum arrangement information 33, to the rear end of the storage area 6A.

Then, the rearrangement unit 43 moves the segments of the volume to be migrated to satisfy the layout indicated by the optimum arrangement information 33. That is, the rearrangement unit 43 moves the segments included in the layout indicated by the optimum arrangement information 33, to the areas consecutive from the front end of the storage area 6A. Specifically, the rearrangement unit 43 selects the records one by one in an ascending order of “node index” of the records in the optimum arrangement information 33. Then, the rearrangement unit 43 moves the segment indicated by “volume index” of the selected record to the divided area indicated by “node index”. The rearrangement unit 43 repeats the selection and movement the number of times indicated by the arrangement number. The rearrangement unit 43 reflects the state after the movement in the arrangement management information 34.

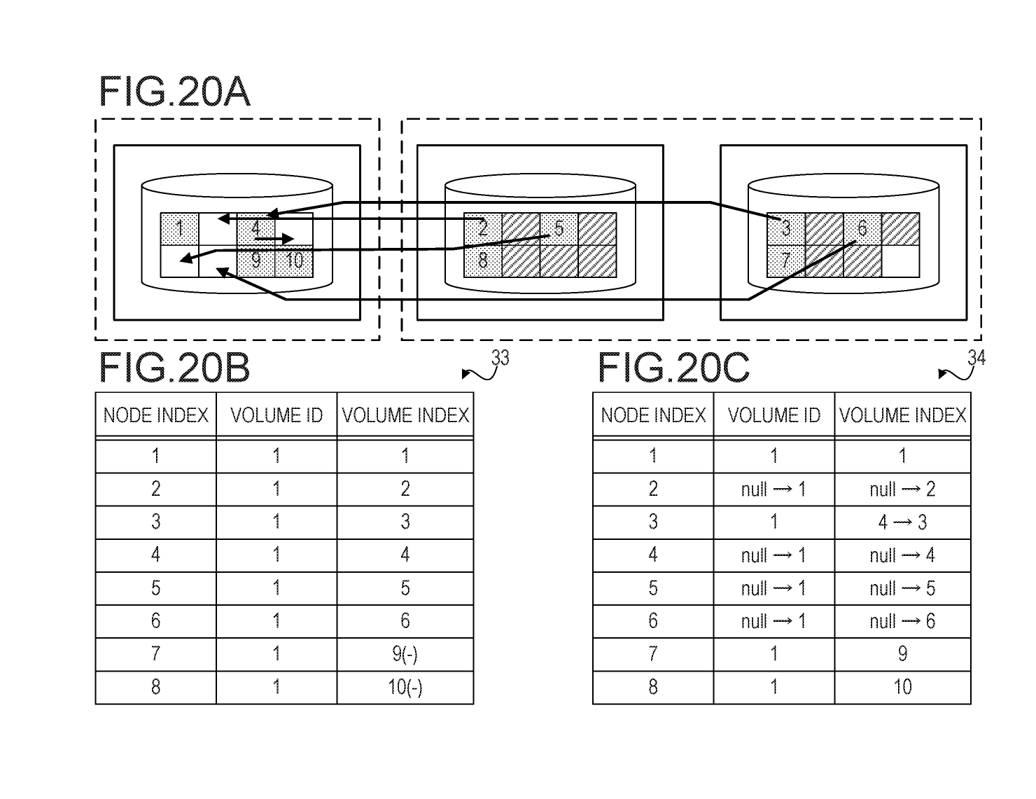

FIGS. 20A to 20C illustrate a movement of the segments included in the layout indicated by the optimum arrangement information 33. FIG. 20A illustrates a state of the movement. FIG. 20B illustrates the optimum arrangement information 33 at the time of the movement. FIG. 20C illustrates a change of the arrangement management information 34 at the time of the movement. Before the movement, the arrangement number is “6”.

As illustrated in FIG. 20A, the rearrangement unit 43 first selects a record with the smallest value of “node index”, that is, “1”, from the optimum arrangement information 33 of FIG. 20B. Since the value of “volume index” of the selected record is “1”, the rearrangement unit 43 arranges segment_1 in divided area_1. In the case of FIG. 20A, segment_1 has already been arranged. In the same manner, the rearrangement unit 43 sequentially selects the records with values of “node index” of “2” to “6”, and arranges segment_2 to segment_6 in divided area_2 to divided area_6. Then, the rearrangement unit 43, as illustrated in FIG. 20C, reflects the state of the storage area 6A after the movement in the arrangement management information 34.

As described above, the rearrangement unit 43 moves the segments included in the layout indicated by the optimum arrangement information 33, to areas consecutive from the front end of the storage area 6A.

The rearrangement unit 43 repeats the above-described expulsion of the segments of a volume other than the migration target and the above-described movement of the segments of the volume to be migrated, which are dropped from the layout indicated by the optimum arrangement information 33. Accordingly, an empty areas is further secured as a temporary area, and the number of segments of a volume to be migrated, which are stored in areas consecutive from the front end of the exchange node is increased.

When the rearrangement of the segments is completed, the migration controller 25 collects and collectively migrates a group of segments with consecutive volume indices headed by the segment stored at the front end of the storage area 6A to the new node 4D using the arrangement management information 34. When the migration is completed, the divided areas of the storage area 6A in which the migrated segments have been stored become empty areas. The migration controller 25 reflects the state of the storage area 6A after the migration in the arrangement management information 34.

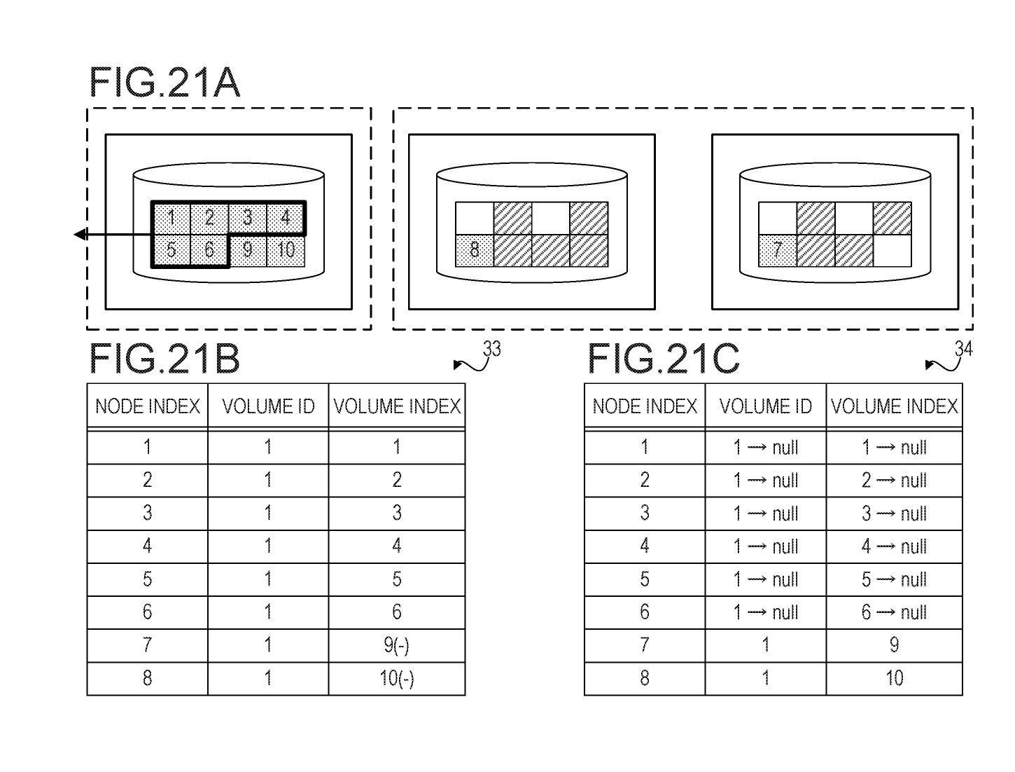

FIGS. 21A to 21C illustrate migration (first time) of a segment group. FIG. 21A illustrates a state of the migration (first time). FIG. 21B illustrates the optimum arrangement information 33 at the time of the migration (first time). FIG. 21C illustrates a change of the arrangement management information 34 at the time of the migration (first time).

As illustrated in FIG. 21A, the migration controller 25 collects and migrates a group of segments with consecutive volume indices from segment_1 stored in divided area_1 to segment_6, with reference to the arrangement management information 34 of FIG. 21B. When the migration is completed, as illustrated in FIG. 21C, the migration controller 25 reflects the state of the storage area 6A after the migration in the arrangement management information 34, and returns the arrangement number to “8”.

The migration controller 25 performs migration of the segment group as described above. In a case where the migration controller 25 tries to move the segments to empty areas but there are no available empty areas, the migration controller 25 collectively migrates a segment group in a range where the consecutive areas are pushed to one end.

When the migration is completed, the areas of the storage area 6A in which the migrated segments have been stored become empty areas. Thus, using the empty areas, the rearrangement controller 24 performs the rearrangement processing on the segments of the volume to be migrated, which have not yet been migrated. That is, the rearrangement controller 24 repeats the above-described processing following the creation of the optimum arrangement information 33.

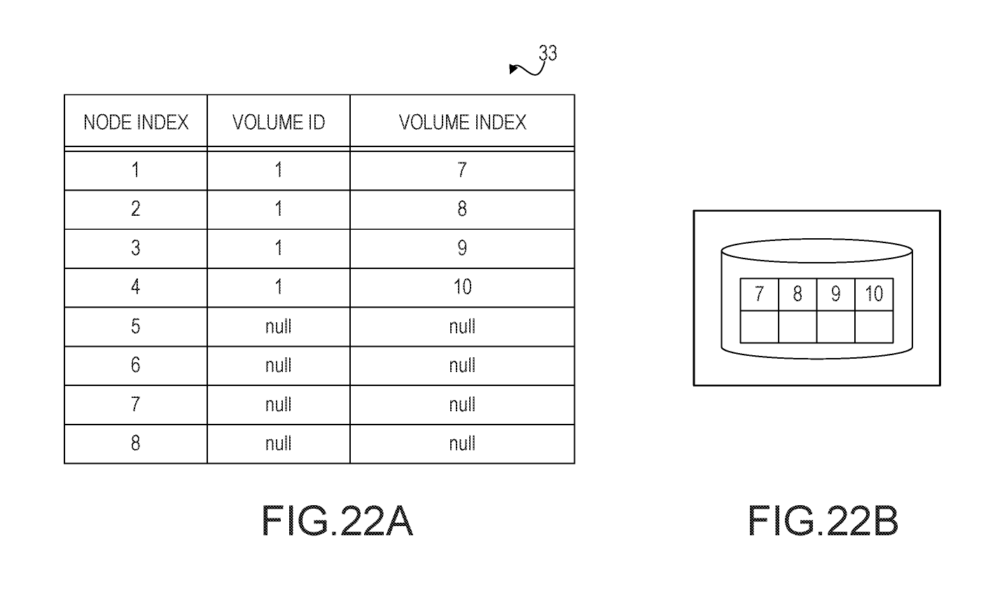

FIGS. 22A and 22B illustrate the optimum arrangement information 33 on segments which have not yet been migrated. FIG. 22A illustrates the optimum arrangement information 33 on the segments which have not yet been migrated. FIG. 22B is a diagram illustrating a layout of the storage area 6A which is indicated by the optimum arrangement information 33.

As described above, when the total number of segments which have not yet been migrated is equal to or smaller than the arrangement number, the optimum arrangement information 33 indicates the following. That is, in this case, the optimum arrangement information 33 indicates a layout in a state where among segments of a volume to be migrated which have not yet been migrated, all segments which have not yet been migrated are consecutively arranged in an ascending order of volume index from one end of the storage area 6A. As described above with reference to FIGS. 21A to 21C, the migration of segment_1 to segment_6 has already been completed, and not-yet-migrated segments are segment_7 to segment_10. The arrangement number is “8”. Accordingly, since the number of segments which have not yet been migrated is equal to or smaller than the arrangement number, the optimum arrangement is placed in a state where all segments which have not yet been migrated are consecutively arranged from one end of the storage area 6A. Referring to the optimum arrangement information 33 of FIG. 22A, in records with “node index” of “1” to “4”, “7” to “10” are stored as “volume index”, respectively. That is, as illustrated in FIG. 22B, the optimum arrangement is placed in a state where segment_7 to segment_10 are stored in divided area_1 to divided area_4, respectively. In the optimum arrangement information 33 of FIG. 22A, records with “node index” of “5” to “8” are also illustrated, but such records are not necessary.

When the creation of the optimum arrangement information 33 is completed, the rearrangement unit 43 rearranges the segments of the migration volume A in the exchange node 4A on the basis of the created optimum arrangement information 33. Since there are no segments of any volume other than the migration target in the exchange node, the expulsion processing is skipped.

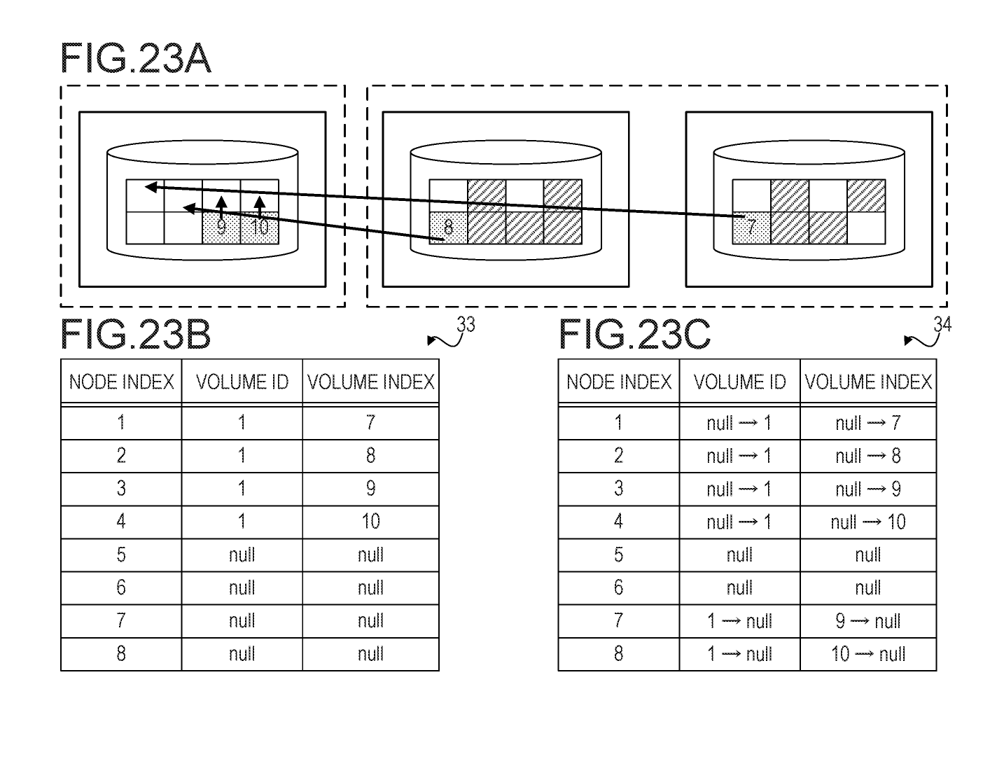

FIGS. 23A to 23C illustrate rearrangement (second time) of segments on the basis of the optimum arrangement information 33. FIG. 23A illustrates a state of the rearrangement (second time). FIG. 23B illustrates the optimum arrangement information 33 at the time of the rearrangement (second time). FIG. 23C illustrates a change of the arrangement management information 34 at the time of the rearrangement (second time). The arrangement number is “8”.

As illustrated in FIG. 23A, the rearrangement is performed such that segment_7 to segment_10 are stored in divided area_1 to divided area_4, respectively. The arrangement management information 34 is updated as illustrated in FIG. 23C.

When the rearrangement is completed, the migration controller 25 collects and collectively migrates, using the arrangement management information 34, a group of segments with consecutive volume indices headed by the segment stored at the front end of the storage area 6A to the storage area 6D of the new node 4D.

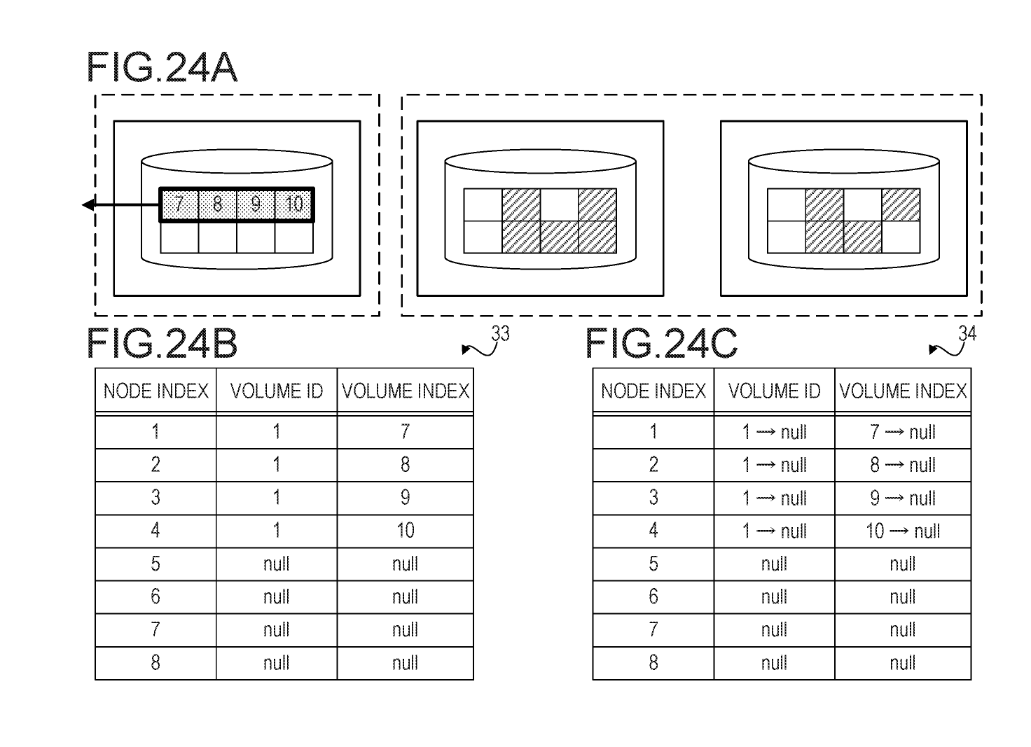

FIGS. 24A to 24C illustrate migration (second time) of a segment group. FIG. 24A illustrates a state of the migration (second time). FIG. 24B illustrates the optimum arrangement information 33 at the time of the migration (second time). FIG. 24C illustrates a change of the arrangement management information 34 at the time of the migration (second time).

As illustrated in FIG. 24A, the migration controller 25 collects and migrates a group of segments with consecutive volume indices from segment_7 stored in divided area_1 to segment_10, with reference to the arrangement management information 34 of FIG. 24C. When the migration is completed, as illustrated in FIG. 24C, the migration controller 25 reflects the state of the storage area 6A after the migration in the arrangement management information 34.

Thus, the migration of all segments of the volume to be migrated is completed. When there are segments of a volume other than the migration target in the exchange node at the time of completing the migration, the rearrangement controller 24 expels these segments to an existing node.

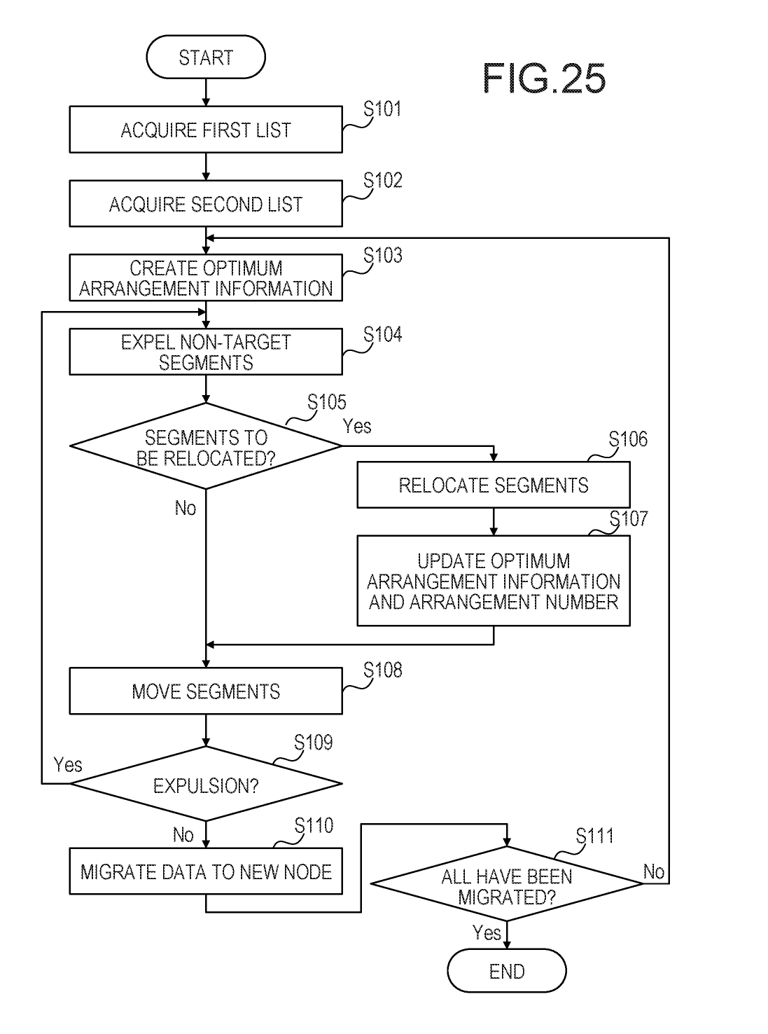

Hereinafter, descriptions will be made on an operation flow of migration of a volume according to the embodiment. FIG. 25 is a flowchart of migration of a volume according to the embodiment.

In FIG. 25, the acquisition unit 41 first acquires the first list 31 (S101). By referring to the first list 31, the creation unit 42 and the rearrangement unit 43 acquire identification information of volumes to be migrated.

The acquisition unit 41 acquires the second list 32 (S102). By referring to the second list 32, the creation unit 42 and the rearrangement unit 43 acquire identification information of volumes other than the migration target.

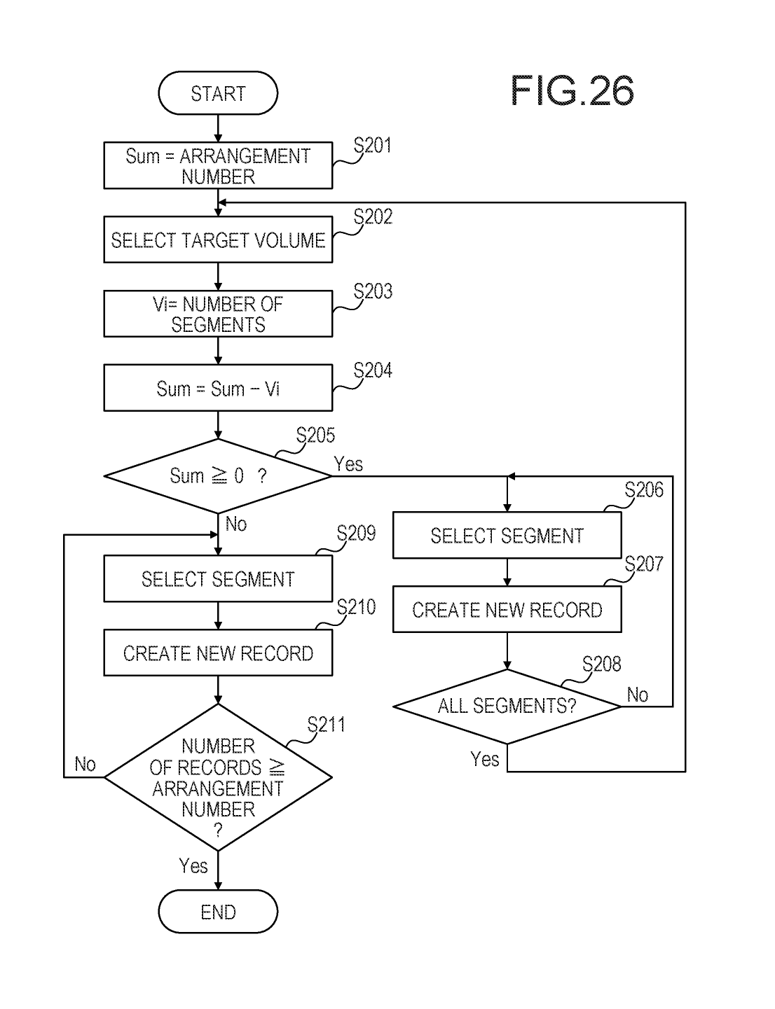

The creation unit 42 creates the optimum arrangement information 33 (S103). That is, the creation unit 42 creates the optimum arrangement information 33 on the basis of an arrangement number and the number of segments of the volume to be migrated. The details of the processing will be described later with reference to FIG. 26.

The rearrangement unit 43 expels segments (referred to as non-target segments) of volumes other than the migration target, which are stored in the storage area of the node to be migrated, to an existing node (S104). If there are some segments unable to be expelled, the rearrangement unit 43 moves the segments to the rear end of the exchange node and updates the optimum arrangement information 33 and the arrangement number to reflect the movement.

Then, the rearrangement unit 43 determines whether there are any segments to be relocated (S105). When it is determined that there is no segment to be relocated in the exchange node (“No” in S105), the processing proceeds to S108. When it is determined that there are some segments to be relocated in the exchange node (“Yes” in S105), the rearrangement unit 43 relocates the segments to the rear end of the storage area of the exchange node (S106). The segments to be relocated are, specifically, segments whose volume indices are different from a value of “volume index” of any of records in the optimum arrangement information 33.

Then, the rearrangement unit 43 reflects, in the optimum arrangement information 33, the fact that the segments relocated in S106 are stored in the rear end divided areas. Then, the rearrangement unit 43 reduces the value of the arrangement number by the number of segments relocated to the rear end (S107).

Then, the rearrangement unit 43 rearranges, in the exchange node, segments of the volume to be migrated, on the basis of the optimum arrangement information 33 (S108).

Then, the rearrangement unit 43 determines whether there are any non-target segments which may be expelled from the exchange node (S109). When it is determined that there are some non-target segments which may be expelled from the exchange node (“Yes” in S109), the processing proceeds to S104. When it is determined that there is no non-target segment which may be expelled from the exchange node (“No” in S109), the migration controller 25 migrates data to a new node (5110). In the data migration, the migration controller 25 collects and collectively migrates, to the new node, a group of segments with consecutive volume indices headed by the segment stored at the front end of the storage area of the node to be migrated.

Then, the migration controller 25 determines whether all segments of all volumes to be migrated have been migrated (S111). When it is determined that any of the segments of the volumes to be migrated have not been migrated (“No” in S111), the processing proceeds to S103. When it is determined that all segments of all volumes to be migrated have been migrated (“Yes” in S111), the processing is ended.

An operation flow of creation of the optimum arrangement information 33 will be specifically described. FIG. 26 is an example of a flowchart of creation of the optimum arrangement information 33.

In FIG. 26, the creation unit 42 first calculates the arrangement number on the basis of the capacity of the storage area of the exchange node, and substitutes the number in a variable “Sum” (S201). Specifically, for example, the creation unit 42 calculates, as the arrangement number, a value obtained by dividing the capacity of the storage area of the exchange node by a segment size.

Then, the creation unit 42 selects one volume from the first list 31 (S202). Here, the selected volume is referred to as a target volume in the following description with reference to FIG. 26. Then, the creation unit 42 calculates, on the basis of the distributive arrangement information for example, the number of segments of the target volume, and substitutes the number the variable in “Vi” (S203). When there are some already migrated segments in the target volume, the number of segments which have not yet been migrated, among segments of the target volume, is substituted in the variable “Vi”.

Then, the creation unit 42 obtains a difference between the arrangement number and the number of segments of the target volume, and substitutes the obtained result in the variable “Sum” (S204). That is, the creation unit 42 calculates (Sum=Sum−Vi).

Then, the creation unit 42 determines, on the basis of the calculation result, whether all segments of the target volume may fit in the exchange node at once. That is, the creation unit 42 determines whether a storage area of the exchange node, in which all segments of the target volume may be stored, may be secured at once. That is, the creation unit 42 determines whether the value of “Sum” is 0 or more (S205). The value of “Sum” of 0 or more indicates that a storage area of the exchange node, in which all segments of the target volume may be stored, may be secured at once. The value of “Sum” of less than 0 indicates that a storage area of the exchange node, in which all segments of the target volume may be stored, is unable to be secured at once.

When it is determined that the storage area may be secured (“Yes” in S205), the creation unit 42 adds, to the optimum arrangement information 33, records corresponding to storage areas in which respective segments of the target volume are to be stored in accordance with an optimum arrangement, in S206 and S207. Specifically, the creation unit 42 first selects the segments one by one in an ascending order of the value of “volume index” among the segments of the target volume, which have not yet been migrated (S206). Then, the creation unit 42 creates a new record of the optimum arrangement information 33, and stores values corresponding to respective data items of the created record (S207). That is, the creation unit 42 stores, in “node index” of the created record, a value obtained by adding “1” to the maximum value of “node index” of the existing record of the optimum arrangement information 33. The creation unit 42 stores the identification information of the target volume in “volume ID”, and stores the value of a volume index of the segment selected in S206 in “volume index”.

Then, the creation unit 42 determines whether all segments of the target volume have been selected in S206 (S208). When it is determined that any of the segments of the target volume has not yet been selected (“No” in S208), the creation unit 42 proceeds the processing to S206, and selects the segments one by one in an ascending order of the value of “volume index” among the unselected segments. On the other hand, when it is determined that all segments of the target volume have been selected (“Yes” in S208), the creation unit 42 proceeds the processing to S202 and selects another volume from the first list 31 to perform the processing following S202.

When it is determined that the storage area is unable to be secured (“No” in S205), the creation unit 42 adds, to the optimum arrangement information 33, records corresponding to storage areas in which respective segments of the target volume are to be stored in accordance with an optimum arrangement, in S209 and S210. The number of records of the optimum arrangement information 33 becomes the same as the arrangement number, at the most. Specifically, the creation unit 42 first selects the segments one by one in an ascending order of the value of “volume index” among the segments of the target volume, which have not yet been migrated (S209). Then, the creation unit 42 creates a new record of the optimum arrangement information 33, and stores values corresponding to respective data items of the created record (S210). That is, the creation unit 42 stores, in “node index” of the created record, a value obtained by adding “1” to the maximum value of “node index” of the existing record of the optimum arrangement information 33. The creation unit 42 stores the identification information of the target volume in “volume ID”, and stores the value of a volume index of the segment selected in S209 in “volume index”.

Then, the creation unit 42 determines whether the number of records of the optimum arrangement information 33 is equal to or larger than the arrangement number (S211). When it is determined that the number of records of the optimum arrangement information 33 is smaller than the arrangement number (“No” in S211), the creation unit 42 proceeds the processing to S209, and selects the segments one by one in an ascending order of the value of “volume index” among the unselected segments. On the other hand, when it is determined that the number of records of the optimum arrangement information 33 is equal to or larger than the arrangement number (“Yes” in S211), the creation unit 42 ends the processing.

As described above, in the rearrangement processing according to the present embodiment, the optimum arrangement information 33 is created first, and the rearrangement of the segments is performed on the basis of the information. By performing the rearrangement as described above, the number of times of copying the segments in the rearrangement may be reduced. Here, in order to explain this effect of the embodiment, the embodiment will be compared with a comparative example in which the rearrangement is performed without designing an optimum arrangement in advance.

In the comparative example, the segments are moved in an ascending order of a volume index to the front end of the storage area of the exchange node in the rearrangement processing. Then, when the divided area serving as a movement destination is not an empty area, the segment which has been stored in the area is relocated to a divided area with the largest node index among empty areas.

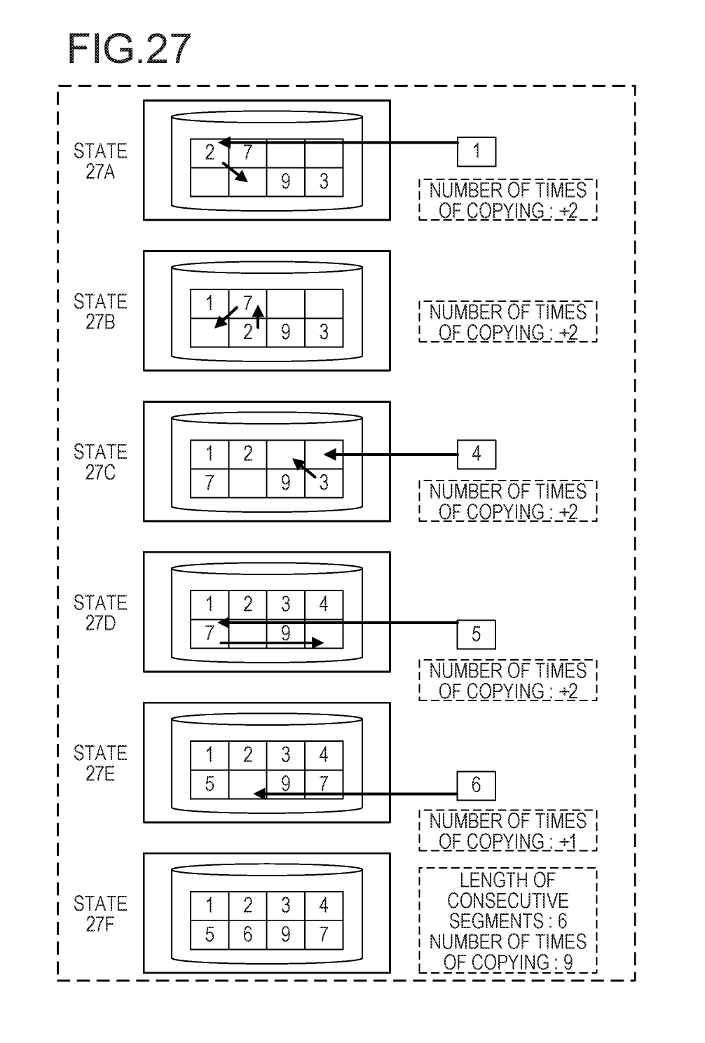

FIG. 27 is a diagram illustrating rearrangement processing in the comparative example. Here, it is assumed that the total number of divided areas of the exchange node is “8”, and the total number of segments of a volume to be migrated is “9” or more. In FIG. 27, the rearrangement is performed in order of STATE27A to STATE27F.

As illustrated in STATE27A, in the initial arrangement prior to the rearrangement processing, the segments with volume indices of “2”, “7”, “9”, and “3” are stored in divided areas with node indices of “1”, “2”, “7”, and “8”, respectively. Here, in the comparative example, segment_1 is stored in divided area_1 first. In divided area_1, segment_2 has been stored originally, and thus, segment_2 is relocated to divided area_6 before segment_1 is moved. As described above, in the movement of segment_1, since segment_1 and segment_2 are copied, the number of times of copying becomes “2”.

In STATE27B, a state where segment_2 is stored in divided area_2 is illustrated. Since the copying is performed in the same manner as for segment_1, the number of times of copying becomes “2”. Similarly, the states of the movement of segment_3 to segment_6 are illustrated in STATE27C to STATE27E.

When the storing of segment_6 in STATE27E is completed, an area to which a segment is to be moved is no longer present. Thus, the exchange node finally has a layout as illustrated in STATE27F. In this manner, in the comparative example, the number of segments with consecutive volume indices headed by the segment stored at the front end of the storage area of the exchange node becomes “6”, and the number of times of copying until the layout is made becomes “9”.

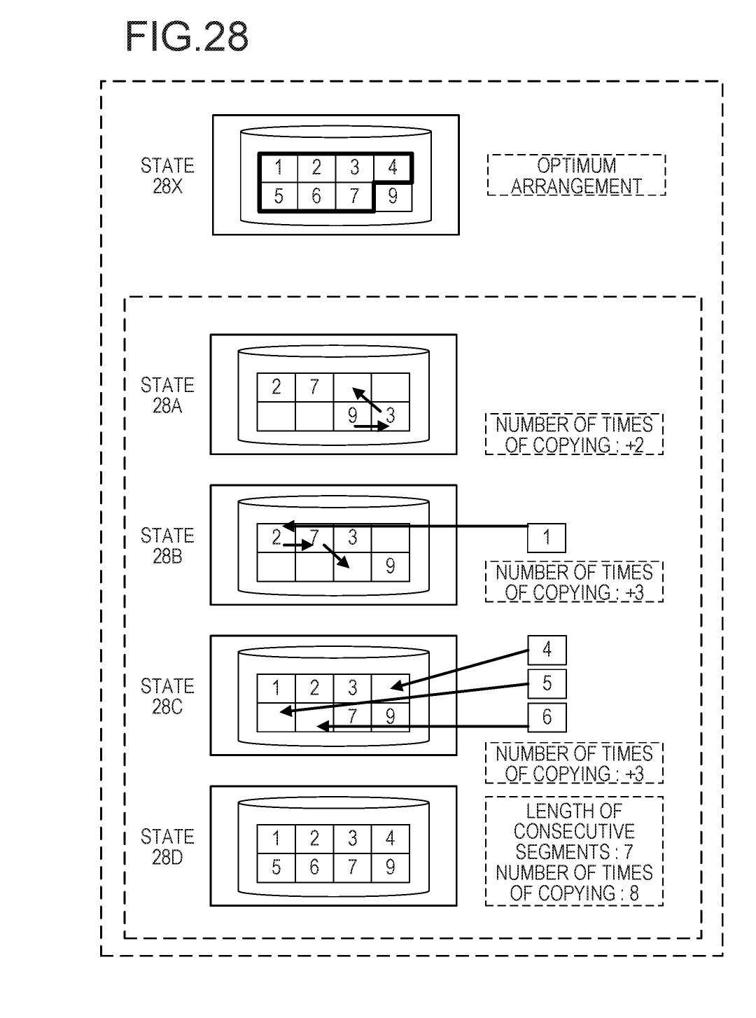

Hereinafter, descriptions will be made on the state where the rearrangement from the same initial arrangement as that in FIG. 27 is performed in the embodiment. FIG. 28 is a diagram illustrating rearrangement processing in the embodiment. STATE28X illustrates the optimum arrangement information 33 after a segment not to be expelled is relocated to the rear end (immediately after S107 of FIG. 25). In FIG. 28, the rearrangement is performed from STATE28A to STATE28D as described above.

In STATE28A, segment_9 not to be expelled is relocated to the rear end first. Here, since segment_3 has been stored originally in divided area_8 at the rear end, segment_3 is moved to divided area_3 on the basis of the optimum arrangement information 33. The number of times of copying in STATE28A is “2”.

In STATE28B, segment_1 is moved to divided area_1 on the basis of the optimum arrangement information 33. Here, since segment_2 has been stored originally in divided area_1, segment_2 is moved to divided area_2 on the basis of the optimum arrangement information 33. Here, since segment_7 has been stored originally in divided area_2, segment_7 is also moved to divided area_7 on the basis of the optimum arrangement information 33. The number of times of copying in STATE28B is “3”.

In STATE28C, segment_4 to segment_6 are moved to the divided area_4 to divided area_6, respectively. The number of times of copying in STATE28C is “3”. Finally, the exchange node has a layout of STATE28D. This is the same as the layout indicated by the optimum arrangement information 33 of STATE28X.

As illustrated in FIG. 28, when the optimum arrangement is designed in advance, it is possible to more efficiently perform data movements as compared to a case where multistage copying such as in defragmentation is allowed.

In the embodiment, the number of segments with consecutive volume indices headed by the segment stored at the front end the storage area of the exchange node becomes “7”, and the number of times of copying until the layout is made becomes “8”.

As compared to those in the comparative example described in FIG. 27, both the number of consecutive segments and the number of times of copying are improved in the embodiment. According to the embodiment, the number of consecutive segments may be larger, and thus an amount of data to be migrated by a single migration may be increased. This enables efficient migration. According to the embodiment, the number of times of copying in the rearrangement may be reduced. This enables efficient rearrangement.

According to the embodiment, the segments of a volume to be migrated, which have been present in the exchange node since before the rearrangement processing, are controlled not expelled to another existing node. This may suppress the communication traffic between the nodes during the rearrangement.

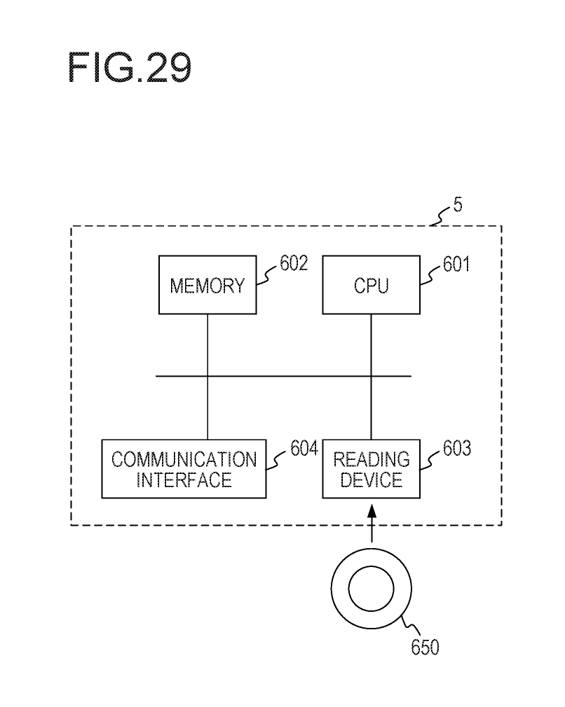

Hereinafter, the hardware configuration of the controller 5 will be described. FIG. 29 illustrates an exemplary hardware configuration of the controller 5 according to the embodiment.

In FIG. 29, the controller 5 includes a central processing unit (CPU) 601, a memory 602, a read device 603, and a communication interface 604. The CPU 601, the memory 602, the read device 603, and the communication interface 604 are connected via a bus or the like.

The CPU 601 executes a program, in which the sequence of the above-described flowchart is described, by using the memory 602 so as to provide a part or all of functions of the respective units other than the list storage unit 27 of the self-reconstruction manager 13 of the controller 5D. The program executed by the CPU 601 may be a storage control program.

The memory 602 is, for example, a semiconductor memory, and is configured to include a random access memory (RAM) area and a read-only memory (ROM) area. The memory 602 provides a part or all of functions of the list storage unit 27 and the arrangement information storage unit 28.

The read device 603 accesses a removable storage medium 650 in accordance with an instruction of the CPU 601. The removable storage medium 650 is realized by, for example, a semiconductor device (a universal serial bus (USB) memory or the like), a medium (a magnetic disk or the like) in which information is input and output by a magnetic action, a medium (compact disc ROM (CD-ROM), digital versatile disc (DVD), or the like) in which information is input and output by an optical action, or the like. The read device 603 is not necessarily included in the controller 5D.

A part of the controller 5D according to the embodiment may be realized by hardware. Otherwise, the controller 5D according to the embodiment may be realized by a combination of software and hardware.

The processing of rearranging the segments is controlled by the rearrangement controller 24, but as described above, the actual operation is performed by the volume management manager 16 or the volume management agent 12 of each node. That is, a part or all of functions of the rearrangement controller 24 may be realized by the volume management manager 16 or the volume management agent 12.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device, comprising:
a processor configured to
receive a designation of a target volume among a plurality of volumes including a plurality of data pieces distributively arranged in a plurality of storage apparatuses, the target volume being to be migrated from a first storage apparatus among the plurality of storage apparatuses to a second storage apparatus different from the plurality of storage apparatuses,
determine a layout of first data pieces of the target volume on basis of a number of data pieces arrangeable in the first storage apparatus and a first number indicating a number of data pieces of the target volume, the first data pieces being to be arranged in the first storage apparatus, and
perform a control operation, on basis of the determined layout, such that the first data pieces are arranged in the first storage apparatus and the arranged first data pieces are collectively migrated to the second storage apparatus.

2. The storage control device according to claim 1, wherein the processor is configured to
determine, when the first number is larger than a second number indicating a number of data pieces arrangeable consecutively in the first storage apparatus, the layout for respective groups of the second number of data pieces such that the second number of data pieces are consecutively arranged in order of address of the data pieces in the target volume from one end of a predetermined storage area of the first storage apparatus, and
perform the control operation for the respective groups on basis of the determined layout and the second number.

3. The storage control device according to claim 2, wherein the processor is configured to
determine, when the first number is larger than the second number, the layout such that second data pieces at address orders later than the second number among data pieces not yet migrated are consecutively arranged from another end of the storage area, the second data pieces being present in the storage area before the determination of the layout, and
perform the control operation for the respective groups on basis of the determined layout and the second number.

4. The storage control device according to claim 3, wherein the processor is configured to
change the second number in accordance with a number of the second data pieces, and
performs the control operation for the respective groups on basis of the determined layout and the changed second number.

5. The storage control device according to claim 1, wherein the processor is configured to
receive a designation of a non-target volume not to be migrated from the first storage apparatus to the second storage apparatus, and
arrange second data pieces in a third storage apparatus among the plurality of storage apparatuses, the second data pieces being present in the first storage apparatus and included in the non-target volume, the third storage apparatus being different from the first storage apparatus.

6. A storage system, comprising:
a plurality of storage apparatuses including a first storage apparatus; and
a second storage apparatus with which the first storage apparatus is to be exchanged, the second storage apparatus being different from the plurality of storage apparatuses,
wherein
the second storage apparatus includes:
a processor configured to
receive a designation of a target volume among a plurality of volumes including a plurality of data pieces distributively arranged in the plurality of storage apparatuses, the target volume being to be migrated from the first storage apparatus to the second storage apparatus,
determine a layout of first data pieces of the target volume on basis of a number of data pieces arrangeable in the first storage apparatus and a number of data pieces of the target volume, the first data pieces being to be arranged in the first storage apparatus, and
perform a control operation, on basis of the determined layout, such that the first data pieces of the target volume are arranged in the first storage apparatus and the arranged first data pieces are collectively migrated to the second storage apparatus.

7. A computer-readable recording medium having stored therein a program that causes a computer to execute a process, the process comprising:
receiving a designation of a target volume among a plurality of volumes including a plurality of data pieces distributively arranged in a plurality of storage apparatuses, the target volume being to be migrated from a first storage apparatus among the plurality of storage apparatuses to a second storage apparatus different from the plurality of storage apparatuses;
determining a layout of first data pieces of the target volume on basis of a number of data pieces arrangeable in the first storage apparatus and a number of data pieces of the target volume, the first data pieces being to be arranged in the first storage apparatus; and
performing a control operation, on basis of the determined layout, such that the first data pieces of the target volume are arranged in the first storage apparatus, and the arranged first data pieces are collectively migrated to the second storage apparatus.
